(19) United States
(12) Patent Application Publication
(10) Pub. No.: US 2023/0206473 A1
(43) Pub. Date: Jun. 29, 2023

(54) COMPUTER-READABLE RECORDING MEDIUM STORING INFORMATION PROCESSING PROGRAM, INFORMATION PROCESSING METHOD, AND INFORMATION PROCESSING DEVICE

(71) Applicant: FUJITSU LIMITED, Kawasaki-shi (JP)

(72) Inventors: Satoru Takahashi, Kawasaki (JP); Yoshiaki Ikai, Fujisawa (JP); Takahiro Saito, Asaka (JP)

(73) Assignee: FUJITSU LIMITED, Kawasaki-shi (JP)

(21) Appl. No.: 17/942,482

(22) Filed: Sep. 12, 2022

(30) Foreign Application Priority Data
Dec. 23, 2021 (JP) 2021-209331

(51) Int. Cl. G06T 7/246; G06T 7/73

(52) U.S. Cl. CPC G06T 7/251; G06T 7/75

(57) ABSTRACT

A non-transitory computer-readable recording medium stores an information processing program for causing a computer to execute processing including: acquiring at least one of time points of start or end of each elemental action related to an action specified on a basis of a moving image of the action; and generating information that enables specification of a time in which the action has been performed on a basis of the acquired time point with reference to a rule that provides at least one of a logical condition for the elemental action related to the action or an order condition between the elemental actions related to the action, the logical condition or the order condition being satisfied in a case where the action is performed.

### CROSS-REFERENCE TO RELATED APPLICATION

This application is based upon and claims the benefit of priority of the prior Japanese Patent Application No. 2021-209331, filed on Dec. 23, 2021, the entire contents of which are incorporated herein by reference.

### FIELD

The embodiments discussed herein are related to an information processing program, an information processing method, and an information processing device.

### BACKGROUND

Conventionally, there is a technique for recognizing an action of a person caught in a moving image. Furthermore, there is a technique for specifying a time in which target work is performed on the basis of a result of recognizing the action of the person. For example, it is conceivable to specify a time from a start time point of the target work to a start time point of work next to the target work as the time in which the target work is performed, on the basis of the result of recognizing the action of the person.

Japanese Laid-open Patent Publication No. 2020-87312 and Japanese Laid-open Patent Publication No. 2021-77230 are disclosed as related art.

### SUMMARY

According to an aspect of the embodiments, a non-transitory computer-readable recording medium stores an information processing program for causing a computer to execute processing including: acquiring at least one of time points of start or end of each elemental action related to an action specified on a basis of a moving image of the action; and generating information that enables specification of a time in which the action has been performed on a basis of the acquired time point with reference to a rule that provides at least one of a logical condition for the elemental action related to the action or an order condition between the elemental actions related to the action, the logical condition or the order condition being satisfied in a case where the action is performed.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of an information processing method according to an embodiment;

FIG. 2 is an explanatory diagram illustrating an example of an information processing system 200;

FIG. 3 is a block diagram illustrating a hardware configuration example of an information processing device 100;

FIG. 4 is a block diagram illustrating an example of a functional configuration of the information processing device 100;

FIG. 5 is a block diagram illustrating a specific example of a functional configuration of the information processing device 100;

FIG. 6 is an explanatory diagram illustrating a flow of specifying a start time point and an end time point of an elemental action;

FIG. 7 is an explanatory diagram illustrating a flow of specifying a time in which a target action has been performed;

FIG. 8 is an explanatory diagram (No. 1) illustrating a variation in a relationship between the target action and the elemental action;

FIG. 9 is an explanatory diagram (No. 2) illustrating a variation in a relationship between the target action and the elemental action;

FIG. 10 is an explanatory diagram (No. 3) illustrating a variation in a relationship between the target action and the elemental action;

FIG. 11 is an explanatory diagram (No. 4) illustrating a variation in a relationship between the target action and the elemental action;

FIG. 12 is an explanatory diagram (No. 5) illustrating a variation in a relationship between the target action and the elemental action;

FIG. 13 is an explanatory diagram (No. 6) illustrating a variation in a relationship between the target action and the elemental action;

FIG. 14 is an explanatory diagram (No. 1) illustrating an example of a time series analysis rule in a first motion example;

FIG. 15 is an explanatory diagram (No. 2) illustrating an example of the time series analysis rule in the first motion example;

FIG. 16 is an explanatory diagram (No. 3) illustrating an example of the time series analysis rule in the first motion example;

FIG. 17 is an explanatory diagram illustrating an example of an action estimation rule in the first motion example;

FIG. 18 is an explanatory diagram illustrating an example of recognizing a basic motion in a normal case;

FIG. 19 is an explanatory diagram (No. 1) illustrating an example of recognizing an elemental action in the normal case;

FIG. 20 is an explanatory diagram (No. 2) illustrating an example of recognizing an elemental action in the normal case;

FIG. 21 is an explanatory diagram illustrating an example of specifying the time in which the target action has been performed in the normal case;

FIG. 22 is an explanatory diagram (No. 1) illustrating a comparative example with an existing method in the normal case;

FIG. 23 is an explanatory diagram (No. 2) illustrating a comparative example with an existing method in the normal case;

FIG. 24 is an explanatory diagram illustrating an example of recognizing a basic motion in an abnormal case;

FIG. 25 is an explanatory diagram (No. 1) illustrating an example of recognizing an elemental action in the abnormal case;

FIG. 26 is an explanatory diagram (No. 2) illustrating an example of recognizing an elemental action in the abnormal case;

FIG. 27 is an explanatory diagram illustrating an example of recognizing that the target action is not performed in the abnormal case;

FIG. 28 is an explanatory diagram (No. 1) illustrating a comparative example with an existing method in the abnormal case;

FIG. 29 is an explanatory diagram (No. 2) illustrating a comparative example with an existing method in the abnormal case;

FIG. 30 is an explanatory diagram illustrating an example of an action estimation rule in a second motion example;

FIG. 31 is an explanatory diagram (No. 1) illustrating an example of specifying the time in which the target action has been performed in the second motion example;

FIG. 32 is an explanatory diagram (No. 2) illustrating an example of specifying the time in which the target action has been performed in the second motion example;

FIG. 33 is an explanatory diagram illustrating an example of an action estimation rule in a third motion example;

FIG. 34 is an explanatory diagram (No. 1) illustrating an example of specifying the time in which the target action has been performed in the third motion example;

FIG. 35 is an explanatory diagram (No. 2) illustrating an example of specifying the time in which the target action has been performed in the third motion example;

FIG. 36 is an explanatory diagram illustrating an example of an action estimation rule in a fourth motion example;

FIG. 37 is an explanatory diagram (No. 1) illustrating an example of specifying the time in which the target action has been performed in the fourth motion example;

FIG. 38 is an explanatory diagram (No. 2) illustrating an example of specifying the time in which the target action has been performed in the fourth motion example; and

FIG. 39 is a flowchart illustrating an example of an overall processing procedure.

### DESCRIPTION OF EMBODIMENTS

As an existing technique, for example, there is a technique of recognizing a plurality of elemental actions included in standard work from characteristic changes in each frame image included in a video, calculating a conviction of each elemental action, and performing integration processing for the convictions of the elemental actions to determine a work action of a worker from among the elemental actions. Furthermore, for example, there is also a technique of recognizing a motion of a worker corresponding to any of individual motions for each body part of the worker, and generating a motion recognition result including start time and end time of the individual motion corresponding to the recognized motion of the worker for each body part of the worker.

However, with the existing technique, it is difficult to accurately specify the time in which the target work has been actually performed. For example, the time from the start time point of the target work to the start time point of work next to the target work may include a time in which another work incidental to the target work is performed, and sometimes does not match the time in which the target work has been actually performed.

In one aspect, an object of the present embodiment is to improve accuracy of specifying a time in which target work has been performed.

Hereinafter, embodiments of an information processing program, an information processing method, and an information processing device will be described in detail with reference to the drawings.

### Example of Information Processing Method According to Embodiment

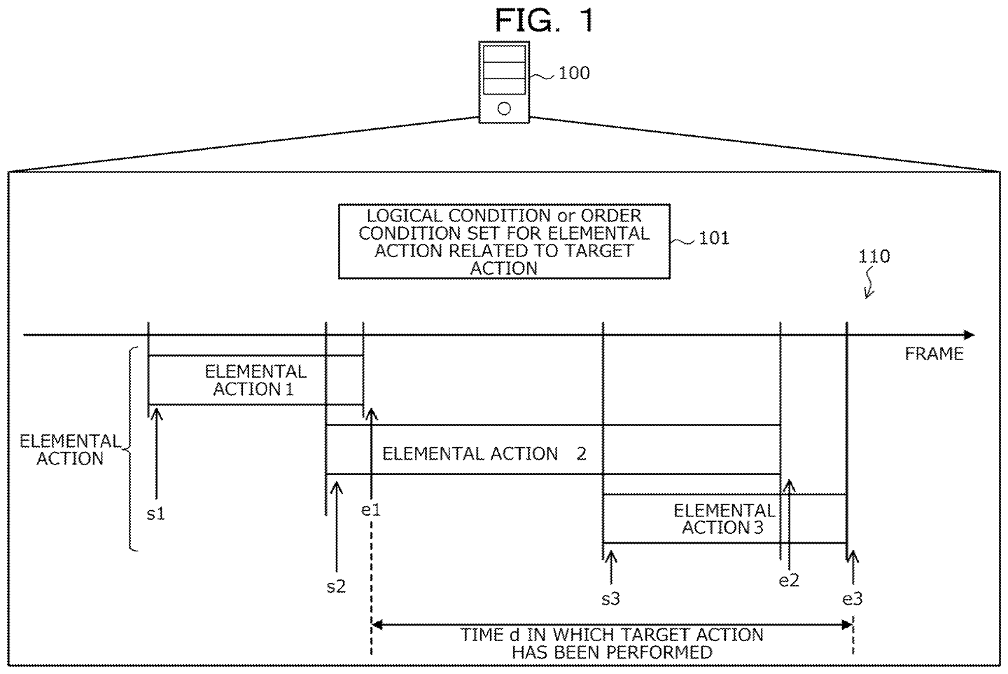

FIG. 1 is an explanatory diagram illustrating an example of an information processing method according to an embodiment. An information processing device 100 is a computer for specifying a time in which target work has been performed. The target work corresponds to, for example, an action of some kind. The action corresponding to the target work may be, for example, a complex action formed by a plurality of actions and including the plurality of actions. For example, the information processing device 100 is a server, a personal computer (PC), or the like.

In the past, in the field of process control, time study for analyzing a time in which target work has been performed may be carried out. For example, there is a method of specifying a time in which target work has been performed on the basis of a result of recognizing an action of a person caught in a moving image. For example, a method of specifying a time from a start time point of the target work to a start time point of work next to the target work as the time in which the target work has been performed on the basis of the result of recognizing the action of the person is conceivable. This method is also called a continuous observation method, for example. Regarding this method, for example, Reference Document 1 below or the like can be referred to, for example.

Reference Document 1: “Personal posture/motion recognition solution by AI”, [Online], [Searched on Nov. 8, 2021], Internet <URL: https://info.hitachi-ics.co.jp/product/activity_evaluation/>

However, it is difficult to accurately specify the time in which the target work has been actually performed by the above-described method. For example, the time from the start time point of the target work to the start time point of work next to the target work may include a time in which another work incidental to the target work has been performed, a time in which no work has been performed, or the like. Therefore, the time specified as the time in which the target work has been performed may not match the time in which the target work has been actually performed.

Therefore, in the present embodiment, an information processing method capable of specifying the time in which the target work has been performed and improving the accuracy of specifying the time in which the target work has been performed will be described. According to the information processing method, for example, by specifying the time in which the target action has been performed, it is possible to specify the time in which the target work corresponding to the target action has been performed.

In FIG. 1, the information processing device 100 stores a predetermined rule 101. The predetermined rule 101 provides at least one of a logical condition for an elemental action related to the target action or an order condition between elemental actions related to the target action, which is satisfied in a case where the target action is performed. For example, it is desirable to specify the time in which the target action has been performed. The target action is, for example, work of some kind.

The elemental action related to the target action is, for example, an elemental action that forms the target action. The elemental action related to the target action may be, for example, an elemental action performed immediately before or immediately after the target action. In the example of FIG. 1, the elemental actions related to the target action are, for example, elemental action 1, elemental action 2, and elemental action 3. The elemental action 1 is an elemental action performed immediately before the target action. The elemental action 1 is, for example, an elemental action incidental to the target action. The target action is formed by the elemental action 2 and the elemental action 3.

For example, the predetermined rule 101 provides the order condition indicating that the elemental action 1, the elemental action 2, and the elemental action 3 are performed in the order of the elemental action 1 the elemental action 2 the elemental action 3 in the case where the target action is performed. For example, the predetermined rule 101 may provide a logical condition indicating that the elemental action 2 and the elemental action 3 are performed at the same time in the case where the target action is performed.

The predetermined rule 101 may further provide a guideline for specifying the time in which the target action has been performed. The predetermined rule 101 may provide, for example, a correspondence relationship between at least one of time points of the start or the end of any elemental action related to the target action and at least one of time points of the start or the end of the time in which the target action has been performed.

In the example of FIG. 1, the predetermined rule 101, for example, indicates that the time point of the end of the elemental action 1 corresponds to the time point of the start of the time in which the target action has been performed, and the time point of the end of the elemental action 3 corresponds to the time point of the end of the time in which the target action has been performed.

(1-1) The information processing device 100 acquires at least one of time points of the start or the end of each of elemental actions related to the target action specified on the basis of a moving image related to the target action.

The information processing device 100 acquires, for example, the moving image related to the target action. The information processing device 100 recognizes a motion for each frame included in the acquired moving image by using a predetermined model such as a deep neural network (DNN). The information processing device 100 specifies, for example, a frame corresponding to an elemental action related to the target action from among the frames included in the moving image on the basis of the recognized motions. The information processing device 100 specifies, for example, any time point of the start or the end of the elemental action related to the target action on the basis of the specified frame.

As illustrated by reference numeral 110, for example, the time point of the start of the elemental action 1 is a time point s1. The time point of the end of the elemental action 1 is a time point e1. The time point of the start of the elemental action 2 is a time point s2. The time point of the end of the elemental action 2 is a time point e2. The time point of the start of the elemental action 3 is a time point s3. The time point of the end of the elemental action 3 is a time point e3.

In the example of FIG. 1, the information processing device 100, for example, specifies the time point s1 of the start and the time point e1 of the end of the elemental action 1, specifies the time point s2 of the start and the time point e2 of the end of the elemental action 2, and specifies the time point s3 of the start and the time point e3 of the end of the elemental action 3.

(1-2) The information processing device 100 refers to the predetermined rule 101 and generates information that enables specification of the time in which the target action has been performed on the basis of the acquired time points. The information that enables specification of the time in which the target action has been performed is, for example, at least one of time points of the start or the end of the time in which the target action has been performed. The information that enables specification of the time in which the target action has been performed may be, for example, a length of the time in which the target action has been performed.

For example, in the case where the predetermined rule 101 provides the order condition, the information processing device 100 determines that the predetermined action has been performed when the order condition provided by the predetermined rule 101 is satisfied on the basis of the acquired time points. In the case of determining that the predetermined action has been performed, for example, the information processing device 100 specifies at least one of time points of the start or the end of the time in which the predetermined action has been performed on the basis of the acquired time points and the guideline indicated by the predetermined rule 101.

In the example of FIG. 1, for example, the information processing device 100 refers to the predetermined rule 101, and specifies the time point of the end of the elemental action 1 as the time point of the start of the time in which the target action has been performed, and specifies the time point of the end of the elemental action 3 as the time point of the end of the time in which the target action has been performed.

Thereby, the information processing device 100 can accurately specify the time in which the target action has been performed. The information processing device 100 can accurately specify the time in which the target work has been performed by, for example, specifying the time in which the target action corresponding to the target work has been performed.

The information processing device 100 can accurately specify the time in which the target work has been performed so that, for example, the time in which the target work of the specified is performed does not include the time in which an elemental action that does not form the target action incidental to the target action has been performed. The information processing device 100 can accurately specify the time in which the target work has been performed so that, for example, the time in which the target work to be specified has been performed does not include the time in which no elemental action has been performed or the like.

Here, the case in which the information processing device 100 specifies any time point of the start or the end of the elemental action related to the target action has been described but the embodiment is not limited to the case. For example, there may be a case where the information processing device 100 acquires any time point of the start or the end of the elemental action related to the target action from another computer. The another computer specifies any time point of the start or the end of the elemental action related to the target action using, for example, a predetermined model.

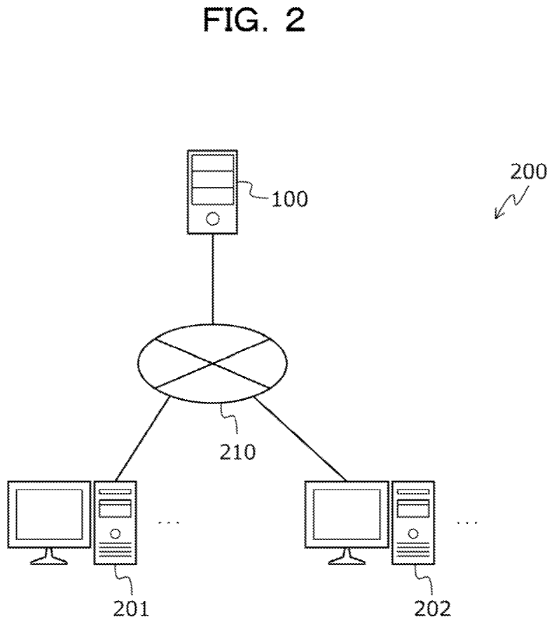

Here, the case where the information processing device 100 operates independently has been described, but the embodiment is not limited to the case. For example, there may be a case where the information processing device 100 cooperates with another computer. Furthermore, for example, there may be a case where a plurality of computers implements functions of the information processing device 100 in a distributed manner. An example of the case where the information processing device 100 cooperates with another computer will be, for example, described below with reference to FIG. 2.

### Example of Information Processing System 200

Next, one example of an information processing system 200 to which the information processing device 100 illustrated in FIG. 1 is applied will be described with reference to FIG. 2.

FIG. 2 is an explanatory diagram illustrating an example of the information processing system 200. In FIG. 2, the information processing system 200 includes the information processing device 100, an elemental action recognition device 201, and a client device 202.

In the information processing system 200, the information processing device 100 and the elemental action recognition device 201 are connected via a wired or wireless network 210. The network 210 is, for example, a local area network (LAN), a wide area network (WAN), or the Internet.

Furthermore, in the information processing system 200, the information processing device 100 and the client devices 202 are connected via the wired or wireless network 210.

The information processing device 100 is a computer for specifying the time in which the target action has been performed. The information processing device 100 may be used by, for example, a system administrator who manages the information processing system 200. The information processing device 100 receives a request to specify the time in which the target action has been performed. The information processing device 100 receives the request to specify the time in which the target action has been performed from another computer, for example. The another computer is, for example, the client device 202. The request may include, for example, a moving image.

The information processing device 100 stores a predetermined rule for specifying the time in which the target action has been performed. The predetermined rule provides at least one of the logical condition for an elemental action related to the target action or the order condition between elemental actions related to the target action, which is satisfied in the case where the target action is performed. The predetermined rule may further provide a guideline for specifying the time in which the target action has been performed. The predetermined rule provides, for example, a correspondence relationship between at least one of time points of the start or the end of any elemental action related to the target action and at least one of time points of the start or the end of the time in which the target action has been performed.

The information processing device 100 acquires at least one of time points of the start or the end of each of elemental actions related to the target action specified on the basis of a moving image related to the target action. The information processing device 100 acquires at least one of time points of the start or the end of each of elemental actions related to the target action by, for example, receiving the time point from the elemental action recognition device 201. For example, the information processing device 100 causes the elemental action recognition device 201 to specify at least one of time points of the start or the end of each of the elemental actions related to the target action by transmitting the moving image included in the request to the elemental action recognition device 201.

The information processing device 100 refers to the predetermined rule and generates information that enables specification of the time in which the target action has been performed on the basis of the acquired time points. The generated information is, for example, at least one of time points of the start or the end of the time in which the target action has been performed. The generated information may be, for example, the length of the time in which the target action has been performed. The information processing device 100 outputs the generated information in a referrable manner from a system user who uses the information processing system 200. The information processing device 100 transmits the generated information to the client device 202, for example. The information processing device 100 is, for example, a server or a PC.

The elemental action recognition device 201 is a computer for recognizing an elemental action. The elemental action recognition device 201 may be used by, for example, the system administrator who manages the information processing system 200. The elemental action recognition device 201 acquires a moving image. The elemental action recognition device 201 includes, for example, a camera device, and acquires the moving image by taking the moving image with the camera device. The elemental action recognition device 201 may acquire the moving image by receiving an input of the moving image, for example. The elemental action recognition device 201 may acquire the moving image by, for example, receiving the moving image from another computer. The another computer is, for example, the client device 202. The another computer may be, for example, the information processing device 100.

The elemental action recognition device 201 recognizes the elemental action on the basis of the acquired moving image. The elemental action recognition device 201 recognizes the elemental action caught in the moving image on the basis of the acquired moving image, using, for example, the predetermined model. The predetermined model is, for example, a DNN. For example, the elemental action recognition device 201 recognizes a motion for each frame included in the acquired moving image by using the predetermined model. The elemental action recognition device 201 specifies, for example, a frame corresponding to the elemental action related to the target action from among the frames included in the moving image on the basis of the recognized motions. The elemental action recognition device 201 specifies, for example, any time point of the start or the end of the elemental action related to the target action on the basis of the specified frame. The elemental action recognition device 201 is, for example, a server or a PC.

The client device 202 is a computer used by a system user who uses the information processing system 200. The client device 202 transmits the request for specifying the time in which the target action has been performed to the information processing device 100 on the basis of an operation input of the system user. The client device 202 receives the information that enables specification of the time in which the target action has been performed from the information processing device 100. The client device 202 outputs the information that enables specification of the time in which the target action has been performed in a referrable manner from the system user. The client device 202 is, for example, a PC, a tablet terminal, or a smartphone.

Here, the case where the information processing device 100 is different from the elemental action recognition device 201 has been described, but the embodiment is not limited to the case. For example, the information processing device 100 may have a function as the elemental action recognition device 201 and may also operate as the elemental action recognition device 201. In this case, the information processing system 200 does not have to include the elemental action recognition device 201.

Here, a case in which the information processing device 100 is a device different from the client device 202 has been described. However, the embodiment is not limited to the case. For example, there may be a case where the information processing device 100 has a function as the client device 202, and also operates as the client device 202. In this case, the information processing system 200 does not have to include the client device 202.

### Hardware Configuration Example of Information Processing Device 100

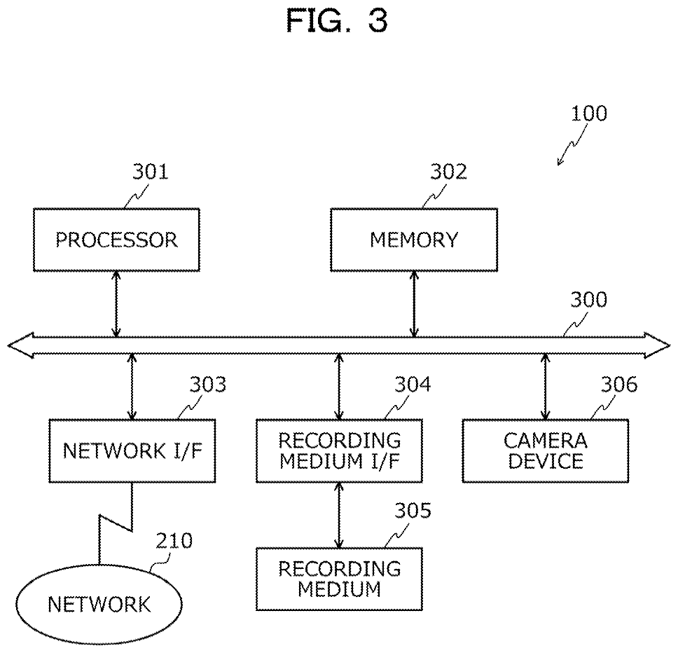

Next, a hardware configuration example of the information processing device 100 will be described with reference to FIG. 3.

FIG. 3 is a block diagram illustrating a hardware configuration example of the information processing device 100. In FIG. 3, the information processing device 100 includes a processor 301, a memory 302, a network interface (I/F) 303, a recording medium I/F 304, a recording medium 305, and a camera device 306. Furthermore, the configuration units are connected to each other by a bus 300.

Here, the processor 301 performs overall control of the information processing device 100. The processor is a central processing unit (CPU), a graphics processing unit (GPU), or the like. The GPU is, for example, an arithmetic unit specialized in image processing.

For example, the memory 302 includes a read only memory (ROM), a random access memory (RAM), a flash ROM, and the like. For example, the flash ROM or the ROM stores various programs, and the RAM is used as a work area for the processor 301. The programs stored in the memory 302 are loaded into the processor 301 to cause the processor 301 to execute coded processing.

The network I/F 303 is connected to the network 210 through a communication line and is connected to another computer via the network 210. Then, the network I/F 303 is responsible for an interface between the network 210 and the inside and controls input and output of data from and to another computer. For example, the network I/F 303 is a modem, a LAN adapter, or the like.

The recording medium I/F 304 controls read and write of data from and to the recording medium 305 under the control of the processor 301. For example, the recording medium I/F 304 is a disk drive, a solid state drive (SSD), a universal serial bus (USB) port, or the like. The recording medium 305 is a nonvolatile memory that stores data written under the control of the recording medium I/F 304. For example, the recording medium 305 is a disk, a semiconductor memory, a USB memory, or the like. The recording medium 305 may be attachable to and detachable from the information processing device 100. The camera device 306 has an imaging element and generates a moving image on the basis of a signal of the imaging element.

The information processing device 100 may include, for example, a keyboard, a mouse, a display, a printer, a scanner, a microphone, or a speaker, in addition to the above-described configuration units Furthermore, the information processing device 100 may include a plurality of the recording medium I/Fs 304 and recording media 305. Furthermore, the information processing device 100 does not have to include the recording medium I/F 304 or the recording medium 305. The information processing device 100 does not have to include the camera device 306.

### Hardware Configuration Example of Elemental Action Recognition Device 201

Since a hardware configuration example of the elemental action recognition device 201 is similar to the hardware configuration example of the information processing device 100 illustrated in FIG. 3, for example, description thereof will be omitted.

### Hardware Configuration Example of Client Device 202

Since a hardware configuration example of the client device 202 is similar to the hardware configuration example of the information processing device 100 illustrated in FIG. 3, for example, description thereof will be omitted. The client device 202 does not have to include a GPU, for example.

### Example of Functional Configuration of Information Processing Device 100

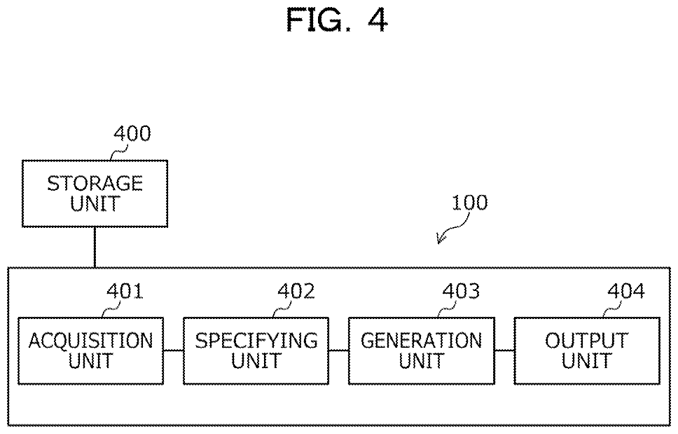

Next, an example of a functional configuration of the information processing device 100 will be described with reference to FIG. 4.

FIG. 4 is a block diagram illustrating an example of a functional configuration of the information processing device 100. The information processing device 100 includes a storage unit 400, an acquisition unit 401, a specifying unit 402, a generation unit 403, and an output unit 404.

The storage unit 400 is implemented by, for example, a storage area such as the memory 302 or the recording medium 305 illustrated in FIG. 3. Hereinafter, a case in which the storage unit 400 is included in the information processing device 100 will be described but the present embodiment is not limited to the case. For example, the storage unit 400 may be included in a device different from the information processing device 100, and stored content of the storage unit 400 may be able to be referred to by the information processing device 100.

The acquisition unit 401 to the output unit 404 function as an example of a control unit. For example, the acquisition unit 401 to the output unit 404 implement functions thereof by causing the processor 301 to execute a program stored in a storage area such as the memory 302 or the recording medium 305 illustrated in FIG. 3 or by the network I/F 303. A processing result of each functional unit is stored in, for example, a storage area such as the memory 302 or the recording medium 305 illustrated in FIG. 3.

The storage unit 400 stores various types of information to be referred to or updated in processing of each functional unit. The storage unit 400 stores, for example, the moving image related to the target action. The moving image relates to, for example, a period during which the target action is determined to have been performed. The moving image includes, for example, a plurality of frames. The moving image is acquired by, for example, the acquisition unit 401.

The target action corresponds to, for example, work of some kind. The target action does not have to correspond to work, for example. The target action is formed by, for example, one or more elemental actions. For example, the target action may be formed by two or more elemental actions. For example, the target action may include two or more elemental actions. More specifically, for example, it is conceivable that the whole of two or more elemental actions performed at the same time is treated as the target action. More specifically, for example, it is conceivable that the whole of two or more elemental actions performed in a predetermined order is treated as the target action.

The storage unit 400 stores, for example, a type of an action to be treated as an elemental action. The action treated as an elemental action may be, for example, an action including two or more elemental actions formed by two or more elemental actions. The type of the action to be treated as an elemental action is set in advance by a user, for example. The type of the action to be treated as an elemental action may be acquired by, for example, the acquisition unit 401.

The storage unit 400 stores, for example, a type of an action to be treated as the target action. The type of the action to be treated as the target action is set in advance by a user, for example. The type of the action to be treated as the target action may be acquired by, for example, the acquisition unit 401.

The storage unit 400 stores, for example, the predetermined model. The predetermined model is, for example, a model that enables recognition of a person, a skeleton, an object, or the like caught in the moving image in order to enable specification of the action to be treated as an elemental action. The predetermined model is, for example, a DNN. The predetermined model is set in advance by the user, for example. The predetermined model may be acquired by, for example, the acquisition unit 401.

The storage unit 400 stores, for example, a first rule. The first rule is a rule that enables specification of the action treated as an elemental action caught in the moving image on the basis of, for example, a person, a skeleton, or an object recognized by the predetermined model. The first rule is, for example, preset by the user. The first rule may be acquired by, for example, the acquisition unit 401.

The storage unit 400 stores a second rule. The second rule is a rule that enables specification of the time in which the target action has been performed. The second rule provides at least one of the logical condition for an elemental action related to the target action or the order condition between elemental actions related to the target action, which is satisfied in the case where the target action is performed.

The elemental action related to the target action is, for example, an elemental action that forms the target action. The elemental action related to the target action may be, for example, an elemental action performed immediately before or immediately after the target action. As the elemental action performed immediately before the target action, for example, an elemental action performed as a preparation for the target action is conceivable. As the elemental action performed immediately after the target action, for example, an elemental action performed according to a result of the target action is conceivable.

The logical condition is, for example, a condition expressed by a logical product AND, a logical sum OR, or a negation NOT for the elemental action related to the target action. For example, the logical condition may be expressed by the logical product AND, and may indicate that two or more elemental actions are performed at the same time as the condition. For example, the logical condition may be expressed by the logical sum OR, and may indicate that at least any elemental action of two or more elemental actions is performed as the condition. For example, the logical condition may be expressed by negation NOT, and may indicate that any elemental action is not performed as the condition. The order condition indicates, for example, a predetermined order in which each elemental action of two or more elemental actions related to the target action is performed.

The second rule may, for example, provide an order condition that defines a predetermined order in which each elemental action of two or more elemental actions related to the target action is performed, which is satisfied in the case where the target action is performed.

The second rule may, for example, provide a logical condition that defines that two or more elemental actions related to the target action are performed at the same time, which is satisfied in the case where the target action is performed. The second rule may provide a logical condition that defines that at least one of the two or more elemental actions related to the target action is performed, which is satisfied in the case where the target action is performed. The second rule may provide a logical condition that defines that one of elemental actions related to the target action is not performed, which is satisfied in the case where the target action is performed.

The second rule may further provide a guideline for specifying the time in which the target action has been performed. The second rule provides, for example, the correspondence relationship between at least one of time points of the start or the end of any elemental action related to the target action and at least one of time points of the start or the end of the time in which the target action has been performed, as a guideline.

The acquisition unit 401 acquires various types of information to be used for processing of each functional unit. The acquisition unit 401 stores the acquired various types of information in the storage unit 400, or outputs the acquired information to each functional unit. Furthermore, the acquisition unit 401 may also output the various types of information stored in the storage unit 400 to each functional unit. The acquisition unit 401 acquires the various sorts of information on the basis of, for example, the operation input by the user. The acquisition unit 401 may receive the various types of information from, for example, a device different from the information processing device 100.

The acquisition unit 401 acquires, for example, the type of the action to be treated as an elemental action. For example, the acquisition unit 401 acquires the type of the action to be treated as an elemental action by accepting the input of the type of the action to be treated as an elemental action on the basis of the operation input of the user. For example, the acquisition unit 401 may acquire the type of the action to be treated as an elemental action by receiving the type of the action from another computer. The another computer is, for example, the client device 202.

The acquisition unit 401 acquires, for example, the type of the action to be treated as the target action. For example, the acquisition unit 401 acquires the type of the action to be treated as the target action by accepting the input of the type of the action to be treated as the target action on the basis of the operation input of the user. For example, the acquisition unit 401 may acquire the type of the action to be treated as the target action by receiving the type of the action from another computer. The another computer is, for example, the client device 202.

The acquisition unit 401 acquires, for example, the above-described predetermined model. For example, the acquisition unit 401 acquires the predetermined model by accepting an input of the predetermined model on the basis of the operation input of the user. For example, the acquisition unit 401 may acquire the predetermined model by receiving the predetermined model from another computer. The another computer is, for example, the client device 202.

The acquisition unit 401 acquires, for example, the above-described first rule. For example, the acquisition unit 401 acquires the first rule by accepting the input of the first rule on the basis of the operation input by the user. For example, the acquisition unit 401 may acquire the first rule by receiving the first rule from another computer. The another computer is, for example, the client device 202.

The acquisition unit 401 acquires, for example, the above-described second rule. For example, the acquisition unit 401 acquires the second rule by accepting the input of the second rule on the basis of the operation input of the user. For example, the acquisition unit 401 may acquire the second rule by receiving the second rule from another computer. The another computer is, for example, the client device 202.

The acquisition unit 401 acquires, for example, the moving image related to the target action. For example, the acquisition unit 401 acquires the moving image by accepting the input of the moving image on the basis of the operation input by the user. For example, the acquisition unit 401 may acquire the moving image by receiving the moving image from another computer. The another computer is, for example, the client device 202.

The acquisition unit 401 acquires the request to generate the information that enables specification of the time in which the target action has been performed. The request may include, for example, the moving image related to the target action. For example, the acquisition unit 401 acquires the request by accepting the input of the request on the basis of the operation input of the user. For example, the acquisition unit 401 may acquire the request by receiving the request from another computer. The another computer is, for example, the client device 202.

The acquisition unit 401 acquires at least one of time points of the start or the end of each of elemental actions related to the target action specified on the basis of a moving image related to the target action. For example, the acquisition unit 401 acquires the time point by accepting the input of at least one of time points of the start or the end of each of elemental actions related to the target action on the basis of the operation input of the user. For example, the acquisition unit 401 may acquire the time point by receiving at least one of time points of the start or the end of each of elemental actions related to the target action from another computer. The another computer is, for example, the elemental action recognition device 201.

The acquisition unit 401 does not need to acquire the moving image related to the target action in the case of acquiring at least one of time points of the start or the end of each of elemental actions related to the target action, for example.

The acquisition unit 401 may accept a start trigger for starting processing of any one of the functional units. The start trigger is, for example, a predetermined operation input made by the user. The start trigger may also be, for example, reception of predetermined information from another computer. The start trigger may be, for example, output of predetermined information by any one of the functional units.

For example, the acquisition unit 401 may accept the acquisition of the moving image as the start trigger for starting processing of the specifying unit 402 and the generation unit 403. For example, the acquisition unit 401 may accept the acquisition of the request to generate the information that enables specification of the time in which the target action has been performed as the start trigger for starting processing of the specifying unit 402 and the generation unit 403. For example, the acquisition unit 401 may accept the acquisition of at least one of time points of the start or the end of each of elemental actions related to the target action as the start trigger for starting the processing of the generation unit 403.

The specifying unit 402 acquires at least one of time points of the start or the end of each of the elemental actions related to the target action on the basis of the moving image related to the target action acquired by the acquisition unit 401. The specifying unit 402 recognizes the motion for each frame included in the moving image, for example. For example, the specifying unit 402 generates skeleton information indicating a position of a target skeleton for each frame included in the moving image, and recognizes the target motion on the basis of the generated skeleton information for each frame included in the moving image. The specifying unit 402 specifies, for example, a frame corresponding to an elemental action related to the target action from among the frames included in the moving image on the basis of the recognized motions.

The specifying unit 402 specifies, for example, any time point of the start or the end of the elemental action related to the target action on the basis of the specified frame. For example, the specifying unit 402 determines whether a ratio of specified frames included in each of two consecutive periods satisfies a condition corresponding to the period. For example, when the ratio of the specified frames included in each of the periods satisfies the condition corresponding to the period, the specifying unit 402 specifies the time point at a boundary between the two periods as the any time point of the start or the end of the elemental action related to the target action. The condition is a threshold set for the ratio of the specified frames among the frames included in each of the periods.

More specifically, for example, the specifying unit 402 determines whether a first condition is satisfied. The first condition is a condition for specifying the time point of the start of the elemental action. For example, the first condition indicates that the ratio of the specified frames among the frames included in a front period is equal to or less than a first threshold value, and the ratio of the specified frames among the frames included in a rear period is equal to or larger than a second threshold, regarding the two consecutive periods. More specifically, for example, in a case of determining that the first condition is satisfied, the specifying unit 402 specifies the time point at a boundary between the two consecutive periods as the time point of the start of the elemental action related to the target action.

More specifically, for example, the specifying unit 402 determines whether a second condition is satisfied. The second condition is a condition for specifying the time point of the end of the elemental action. For example, the second condition indicates that the ratio of the specified frames among the frames included in the front period is equal to or larger than a third threshold, and the ratio of the specified frames among the frames included in the rear period is equal to or less than a fourth threshold, regarding the two consecutive periods. More specifically, for example, in a case of determining that the second condition is satisfied, the specifying unit 402 specifies the time point at a boundary between the two consecutive periods as the time point of the end of the elemental action related to the target action. Thereby, the specifying unit 402 can obtain information that can be used to specify the time in which the target action has been performed.

For example, in the case where the ratio of the specified frames included in each of the periods satisfies the condition corresponding to the period, the specifying unit 402 may specify a time point located at a point other than the boundary between the two periods as the any time point of the start or the end of the elemental action related to the target action. More specifically, for example, the specifying unit 402 may specify a central time point of the latter half period as the any time point of the start or the end of the elemental action related to the target action.

The generation unit 403 refers to the second rule and generates the information that enables specification of the time in which the target action has been performed on the basis of the specified time points. The information generated by the generation unit 403 is, for example, information including at least one of time points of the start or the end of the time in which the target action has been performed. The information generated by the generation unit 403 may be, for example, information including the length of the time in which the target action has been performed.

For example, in a case where the second rule indicates the logical condition, the generation unit 403 determines whether the logical condition indicated by the second rule is satisfied on the basis of the acquired time points. For example, the generation unit 403 determines that a predetermined action has been performed when the logical condition indicated by the second rule is satisfied. For example, in the case of determining that the predetermined action has been performed, the generation unit 403 specifies at least one of time points of the start or the end of the time in which the predetermined action has been performed on the basis of the acquired time points and the guideline indicated by the second rule. For example, the generation unit 403 generates the information that enables specification of the time in which the target action has been performed on the basis of the specified time points.

For example, in a case where the second rule indicates the order condition, the generation unit 403 determines whether the order condition indicated by the second rule is satisfied on the basis of the acquired time points. For example, the generation unit 403 determines that a predetermined action has been performed when the order condition indicated by the second rule is satisfied. For example, in the case of determining that the predetermined action has been performed, the generation unit 403 specifies at least one of time points of the start or the end of the time in which the predetermined action has been performed on the basis of the acquired time points and the guideline indicated by the second rule. For example, the generation unit 403 generates the information that enables specification of the time in which the target action has been performed on the basis of the specified time points.

For example, in a case where the second rule indicates the logical condition and the order condition, the generation unit 403 determines whether the logical condition and the order condition indicated by the second rule are satisfied on the basis of the acquired time points. For example, the generation unit 403 determines that a predetermined action has been performed when the logical condition and the order condition indicated by the second rule are satisfied. For example, in the case of determining that the predetermined action has been performed, the generation unit 403 specifies at least one of time points of the start or the end of the time in which the predetermined action has been performed on the basis of the acquired time points and the guideline indicated by the second rule. For example, the generation unit 403 generates the information that enables specification of the time in which the target action has been performed on the basis of the specified time points. Thereby, the generation unit 403 can make the information available, which enables accurate specification of the time in which the target action has been performed.

The output unit 404 outputs a processing result of at least any one of the functional units. An output format is, for example, display on a display, print output to a printer, transmission to an external device by the network I/F 303, or storage in the storage area of the memory 302, the recording medium 305, or the like. This allows the output unit 404 to notify the user of the processing result of at least any one of the functional units, and achievement of enhancement of convenience of the information processing device 100.

The output unit 404 outputs, for example, the information generated by the generation unit 403. The output unit 404 displays, for example, the information generated by the generation unit 403 on the display. The output unit 404 may transmit the information generated by the generation unit 403 to another computer, for example. The another computer is, for example, the client device 202. Thereby, the output unit 404 can make the information generated by the generation unit 403 referrable to the user. The output unit 404 can enable the user to accurately grasp the time in which the target action has been performed, for example.

### Specific Example of Functional Configuration of Information Processing Device 100

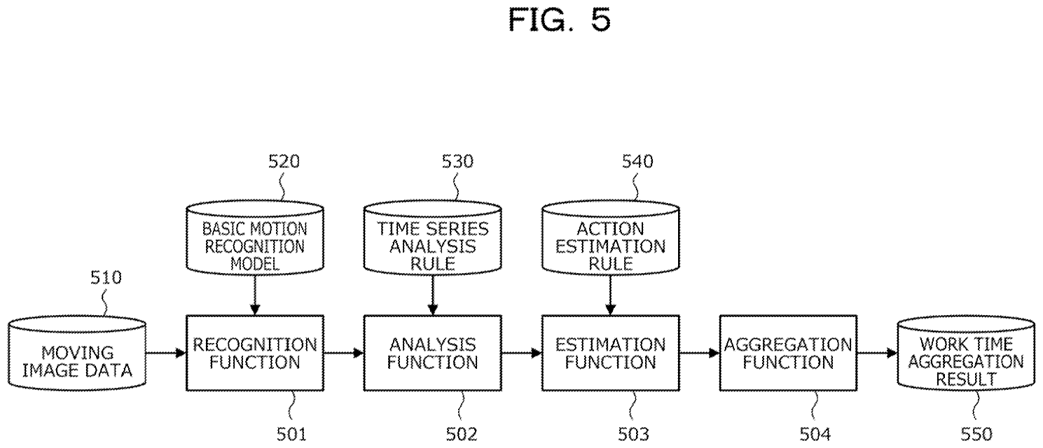

Next, a specific example of the functional configuration of the information processing device 100 will be described with reference to FIG. 5.

FIG. 5 is a block diagram illustrating a specific example of the functional configuration of the information processing device 100. The information processing device 100 has a recognition function 501, an analysis function 502, an estimation function 503, and an aggregation function 504. The information processing device 100 acquires moving image data 510. The information processing device 100 has a basic motion recognition model 520, a time series analysis rule 530, and an action estimation rule 540.

The basic motion recognition model 520 is, for example, a DNN. The basic motion recognition model 520 is trained on the basis of a plurality of training data to be able to recognize a basic motion of a person caught in a frame included in the moving image data, for example. The training data represents, for example, a standard of how to recognize the basic motion of the person. The basic motion recognition model 520 may be further trained to be able to recognize attribute information of a person, a skeleton, or an object caught in the frame included in the moving image data, for example. The training data represents, for example, a standard of how to recognize the attribute information of a person, a skeleton, or an object. The basic motion recognition model 520 may be further trained to be able to recognize space information for evaluating a positional relationship between persons, a person and an object, or objects caught in the frame included in the moving image data, for example. The training data represents, for example, a standard of how to recognize the positional relationship between persons, a person and an object, or objects.

The time series analysis rule 530 is a rule that defines how to specify the time point of the start and the time point of the end of the elemental action corresponding to the basic motion. The time series analysis rule 530 defines, for example, how to specify the time point of the start and the time point of the end of the elemental action corresponding to the basic motion on the basis of a statistic amount of the basic motion in a certain period. For example, the time series analysis rule 530 determines how to specify the time point of the start and the time point of the end of the elemental action corresponding to the basic motion on the basis of the statistic amount of the basic motion in each of two consecutive periods.

More specifically, for example, the time series analysis rule 530 defines which elemental action corresponds to the basic motion. More specifically, for example, the time series analysis rule 530 specifies the length of each period of the two consecutive periods. More specifically, for example, the time series analysis rule 530 defines a first threshold and a second threshold to be compared with the statistic amount of the basic motion in each period of the two consecutive periods, which are used for specifying the time point of the start of the elemental action. More specifically, for example, the time series analysis rule 530 defines a third threshold and a fourth threshold to be compared with the statistic amount of the basic motion in each period of the two consecutive periods, which are used for specifying the time point of the end of the elemental action.

The action estimation rule 540 is a rule that defines how to estimate the time in which the target action corresponding to work has been performed. The action estimation rule 540 defines, for example, the logical condition for the elemental action related to the target action, the order condition between the elemental actions related to the target action, or the like, which is satisfied in the case where the target action has been performed, in order to detect that the target action has been performed.

The action estimation rule 540 defines, for example, how to estimate the time in which the target action has been performed on the basis of the time point of the start or the end of the elemental action related to the target action in the case where the target action has been performed. The action estimation rule 540 defines, for example, the correspondence relationship between the time point of the start or the end of the elemental action related to the target action and the time point of the start or the end of the time in which the target action has been performed. More specifically, for example, the action estimation rule 540 defines which time point of the start or the end of the elemental action related to the target action is adopted as the time point of the start or the end of the time in which the target action has been performed.

The recognition function 501 recognizes, for each frame included in the moving image data 510, the basic motion of the person caught in the frame, using the basic motion recognition model 520. The recognition function 501 generates time series data of the basic motions in which the recognized basic motions are arranged along a time axis. The recognition function 501 may recognize additional information for each frame included in the moving image data 510, using the basic motion recognition model 520. For example, the recognition function 501 may recognize the attribute information of a person, a skeleton, or an object caught in a frame included in the moving image data 510 as the additional information. The recognition function 501 may recognize, for example, the space information for evaluating the positional relationship between persons, a person and an object, or objects caught in the frame included in the moving image data 510 as the additional information.

The analysis function 502 analyzes the time series data of the basic motions with reference to the time series analysis rule 530, and specifies the time point of the start and the time point of the end of the elemental action corresponding to the basic motion on the basis of the statistic amount of the basic motions in a certain period. The statistic amount is, for example, a ratio indicating how many frames in which the basic motion is recognized are included in the frames of the certain period.

For example, the analysis function 502 specifies the time point of the boundary of the two consecutive periods as the time point of the start of the elemental action in a case where the statistic amount in the front period is equal to or less than the first threshold and the statistic amount in the rear period is equal to or larger than the second threshold, of the two consecutive periods, for example. For example, the analysis function 502 specifies the time point of the boundary of the two consecutive periods as the time point of the end of the elemental action in a case where the statistic amount in the front period is equal to or larger than the third threshold and the statistic amount in the rear period is equal to or less than the fourth threshold, of the two consecutive periods, for example.

The estimation function 503 specifies the time in which the target action corresponding to work has been performed on the basis of the time point of the start and the time point of the end of the elemental action with reference to the action estimation rule 540. The estimation function 503 determines, for example, whether a predetermined condition such as the logical condition or the order condition indicated by the action estimation rule 540 is satisfied. In the case of determining that the predetermined condition such as the logical condition or the order condition indicated by the action estimation rule 540 is satisfied, for example, the estimation function 503 determines that the target action has been performed.

In the case of determining that the target action has been performed, the estimation function 503 adopts the time point of the start or the end of any elemental action as the time point of the start or the end of the time in which the target action has been performed with reference to the action estimation rule 540. The estimation function 503 specifies the time in which the target action has been performed on the basis of the time point of the start or the end of the time in which the adopted target action has been performed.

Here, the estimation function 503 specifies the time in which the target action has been performed for each time in a case where the target action has been performed a plurality of times. For example, the target action of the same kind may be performed a plurality of times. The target actions of two or more different types may be performed.

The aggregation function 504 generates a work time aggregation result 550 by aggregating the time in which the target action has been performed. The aggregation function 504 aggregates, for example, the time in which the target action has been performed for each type of the target action, and generates the work time aggregation result 550 including a total time in which the target actions of the respective types have been performed. The aggregation function 504 outputs the generated work time aggregation result 550.

(Flow of Operation of Information Processing Device 100)

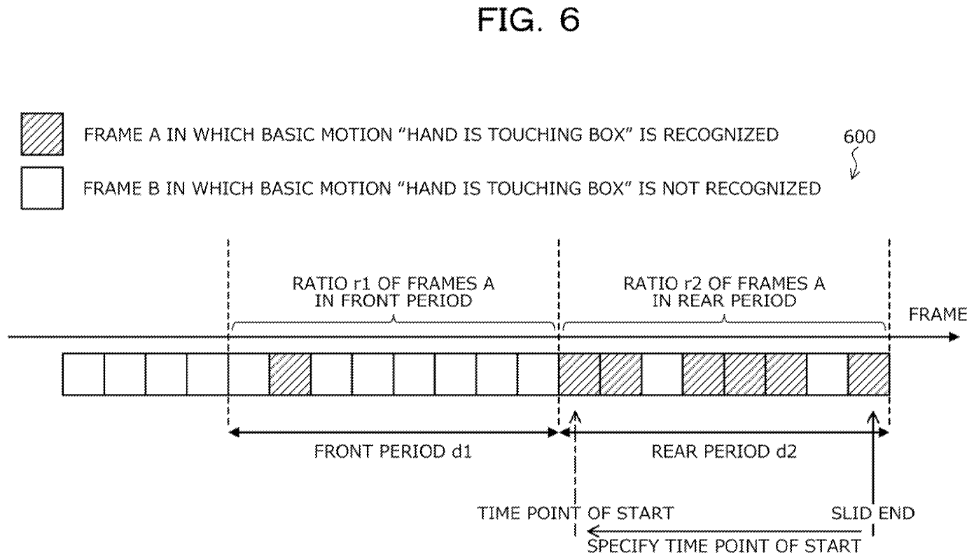

Next, a flow of an operation of the information processing device 100 will be described with reference to FIGS. 6 to 13. For example, first, a flow of the information processing device 100 specifying the time point of the start and the time point of the end of the elemental action will be described with reference to FIG. 6. In the following description, the time point is expressed by “a number of a frame included in the moving image data”.

FIG. 6 is an explanatory diagram illustrating the flow of specifying the time point of the start and the time point of the end of the elemental action. In FIG. 6, the information processing device 100 has a basic motion recognition model and a time series analysis rule. The basic motion recognition model enables, for example, recognition of the basic motion caught in the frame included in the moving image data. The time series analysis rule defines how to specify the time point of the start and the time point of the end of the elemental action corresponding to the basic motion.

In the example of FIG. 6, the information processing device 100 specifies the time point of the start of an elemental action “reach the hand for the box”. For example, the information processing device 100 recognizes a basic motion “the hand is touching the box” corresponding to the elemental action “reach the hand for the box” for each frame included in the moving image data, using a predetermined model. For example, as illustrated by reference numeral 600, the information processing device 100 generates time series data of the basic motion in which results of recognizing the basic motion “the hand is touching the box” for each frame are arranged along a time axis.

In the example of FIG. 6, the frame in which the basic motion “the hand is touching the box” is recognized is illustrated using a hatch with falling diagonal strokes from top left to bottom right. In the following description, the frame in which the basic motion “the hand is touching the box” is recognized may be described as “frame A”. The frames in which the basic motion “the hand is touching the box” is not recognized are illustrated as plain. In the following description, the frame in which the basic motion “the hand is touching the box” is not recognized may be described as “frame B”.

For example, the information processing device 100 reads a length d1 of the front period and a length d2 of the rear period and reads the first threshold and the second threshold with reference to the time series analysis rule. For example, the information processing device 100 calculates the ratio of the frames in which the basic motion is recognized in each period while sliding backward the two periods of the consecutive front period and rear period by a fixed amount from the beginning of the moving image data. More specifically, for example, as illustrated by reference numeral 600, the information processing device 100 calculates a ratio r1 of the frame A in the front period and a ratio r2 of the frame A in the rear period.

For example, the information processing device 100 determines whether the ratio r1 of the frame A in the front period is equal to or less than the first threshold. For example, the information processing device 100 determines whether the ratio r2 of the frame A in the rear period is equal to or larger than the second threshold. For example, as illustrated by reference numeral 600, the information processing device 100 specifies the time point of the beginning of the rear period as the time point of the start of the elemental action “reach the hand for the box” in the case where the ratio r1 is equal to or smaller than the first threshold and the ratio r2 is equal to or larger than the second threshold.

Thereby, the information processing device 100 can accurately specify the time point of the start of the elemental action. The information processing device 100 can prevent the time point in which the basic motion is being performed for a purpose other than the elemental action and the elemental action is not performed from being erroneously specified as the time point of the start of the elemental action. The information processing device 100 can prevent the time in which the elemental action has been performed from being fragmented even if the time in which the basic motion is not recognized is included in the time in which the elemental action has been actually performed.

Similarly, the information processing device 100 specifies the time point of the end of the elemental action “reach the hand for the box”. For example, the information processing device 100 reads the third threshold and the fourth threshold with reference to the time series analysis rule. For example, the information processing device 100 calculates the ratio of the frames in which the basic motion is recognized in each period while sliding backward the two periods of the consecutive front period and rear period by a fixed amount at or after the time point of the start of the elemental action “reach the hand for the box”. More specifically, for example, the information processing device 100 calculates the ratio r1 of the frame A in the front period and the ratio r2 of the frame A in the rear period.

For example, the information processing device 100 determines whether the ratio r1 of the frame A in the front period is equal to or larger than the third threshold. For example, the information processing device 100 determines whether the ratio r2 of the frame A in the rear period is equal to or less than the fourth threshold. For example, the information processing device 100 specifies the time point of the beginning of the rear period as the time point of the end of the elemental action “reach the hand for the box” in the case where the ratio r1 is equal to or larger than the third threshold and the ratio r2 is equal to or less than the fourth threshold.

Thereby, the information processing device 100 can accurately specify the time point of the end of the elemental action. The information processing device 100 can prevent the time point in which the basic motion is being performed for a purpose other than the elemental action and the elemental action is not performed from being erroneously specified as the time point of the end of the elemental action. The information processing device 100 can prevent the time in which the elemental action has been performed from being fragmented even if the time in which the basic motion is not recognized is included in the time in which the elemental action has been actually performed.

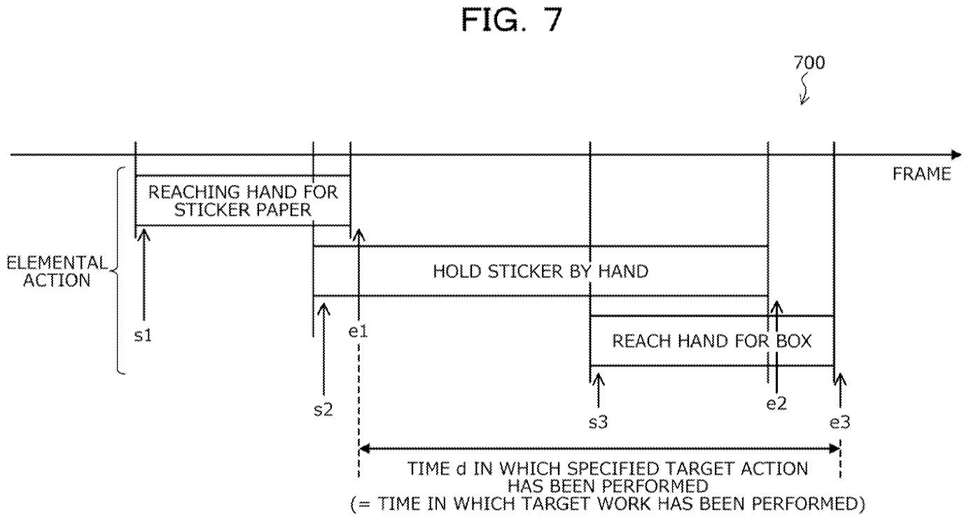

Next, a flow in which the information processing device 100 specifies the time in which the target action has been performed will be described with reference to FIG. 7. The target action is, for example, “stick the sticker on the box”.

FIG. 7 is an explanatory diagram illustrating a flow of specifying a time in which a target action has been performed. In FIG. 7, the information processing device 100 is assumed to specify the time points of the start and the end of the elemental action “reach the hand for the sticker paper”, the time points of the start and the end of the elemental action “hold the sticker by hand”, and the time points of the start and the end of the elemental action “reach the hand for the box”.

As illustrated by reference numeral 700, the time point of the start of the elemental action “reach the hand for the sticker paper” is s1. The time point of the end of the elemental action “reach the hand for the sticker paper” is e1. The time point of the start of the elemental action “hold the sticker by hand” is s2. The time point of the end of the elemental action “hold the sticker by hand” is e2. The time point of the start of the elemental action “reach the hand for the box” is s3. The time point of the end of the elemental action “reach the hand for the box” is e3.

The information processing device 100 has the action estimation rule. The action estimation rule is a rule that defines how to estimate the time in which the target action corresponding to work has been performed. The action estimation rule is assumed to define, for example, the order condition between the elemental actions related to the target action, which is satisfied in the case where the target action has been performed, in order to detect that the target action has been performed. The action estimation rule further includes, for example, output control information that defines the correspondence relationship between the time point of the start or the end of the elemental action related to the target action and the time point of the start or the end of the time in which the target action has been performed.

The information processing device 100 specifies the time points of the start and the end of the time in which the target action has been performed on the basis of the time point of the start or the end of the elemental action with reference to the action estimation rule. The information processing device 100 specifies, for example, the time point e1 of the end of the elemental action “reach the hand for the sticker paper” as the time point of the start of the target action “stick the sticker on the box” with reference to the action estimation rule. The information processing device 100 specifies, for example, the time point e3 of the end of the elemental action “reach the hand for the box” as the time point of the end of the target action “stick the sticker on the box” with reference to the action estimation rule. The information processing device 100 specifies the time in which the target action “stick the sticker on the box” has been performed on the basis of the time point of the start and the end of the target action “stick a sticker on the box”.

Thereby, the information processing device 100 can accurately specify the time in which the target action has been performed on the basis of the output control information. The information processing device 100 can specify, for example, the time in which the target action has been performed such that the time in which the target action has been performed does not include the time in which an elemental action incidental to the target action has been performed or a blank time in which no elemental action has been performed.

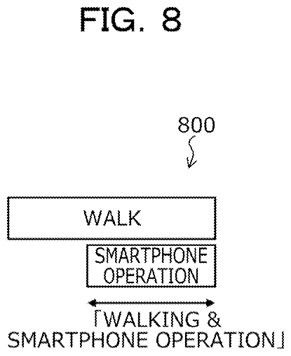

Next, variations in a relationship between the target action and the elemental action will be described with reference to FIGS. 8 to 13. The relationship between the target action and the elemental action is defined by, for example, the logical condition or the order condition indicated by the action estimation rule.

FIGS. 8 to 13 are explanatory diagrams illustrating variations in a relationship between the target action and the elemental action. As illustrated in FIG. 8, for example, it is conceivable that the target action is formed by an elemental action “walk” and an elemental action “smartphone operation”. For example, as illustrated by reference numeral 800, in a case where the elemental action “walk” and the elemental action “smartphone operation” are performed at the same time, the elemental action “walk” and the elemental action “smartphone operation” form a target action “walking & smartphone operation”.

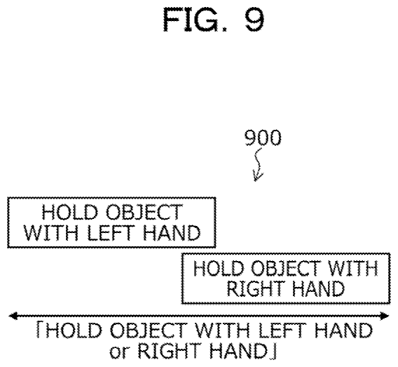

In this case, the action estimation rule provides, for example, the logical product AND of the elemental action “walk” and the elemental action “smartphone operation” as the logical condition. The action estimation rule indicates that, for example, the time point of the start of the elemental action “smartphone operation” corresponds to the time point of the start of the target action “walking & smartphone operation”. The action estimation rule indicates that, for example, the time point of the end of the elemental action “smartphone operation” corresponds to the time point of the end of the target action “walking & smartphone operation”. Next, description proceeds to FIG. 9.

As illustrated in FIG. 9, for example, it is conceivable that the target action is formed by either an elemental action “hold an object with the left hand” or an elemental action “hold an object with the right hand”. For example, as illustrated by reference numeral 900, in a case where at least one of the elemental actions “hold an object with the left hand” and the elemental action “hold an object with the right hand” is performed, the elemental action forms the target action “hold an object with the left or right hand”.

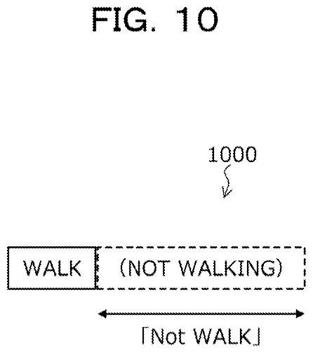

In this case, the action estimation rule provides, for example, the logical sum OR of the elemental action “hold an object with the left hand” and the elemental action “hold an object with the right hand” as the logical condition. The action estimation rule indicates that, for example, the time point of the start of either the elemental action “hold an object with the left hand” or the elemental action “hold an object with the right hand” corresponds to the time point of the start of the target action “hold an object with the left or right hand”. The action estimation rule indicates that, for example, the time point of the end of either the elemental action “hold an object with the left hand” or the elemental action “hold an object with the right hand” corresponds to the time point of the end of the target action “hold an object with the left or right hand”. Next, description proceeds to FIG. 10.

As illustrated in FIG. 10, for example, it is conceivable that the target action is defined by the elemental action “walk”. For example, as illustrated by reference numeral 1000, in a case where the elemental action “walk” is not performed, the target action “not walking” will be performed.

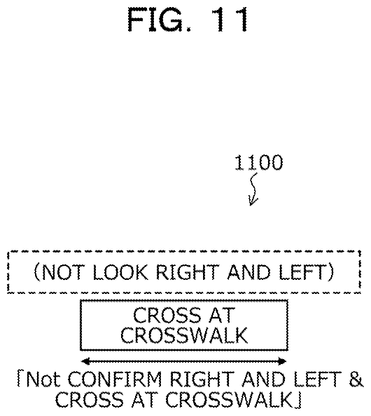

In this case, the action estimation rule provides, for example, the negation NOT of the elemental action “walk” as the logical condition. The action estimation rule indicates that, for example, the time point of the end of the elemental action “walk” corresponds to the time point of the start of the target action “not walking”. The action estimation rule indicates that, for example, the time point of the start of the elemental action “walk” corresponds to the time point of the end of the target action “not walking”. Next, description proceeds to FIG. 11.

As illustrated in FIG. 11, for example, it is conceivable that the target action is defined by an elemental action “look right and left” and an elemental action “cross at a crosswalk”. For example, as illustrated by reference numeral 1100, in a case where the elemental action “look right and left” is not performed and the elemental action “cross at a crosswalk” is performed, a target action “Not confirm right and left & cross at a crosswalk” will be performed.

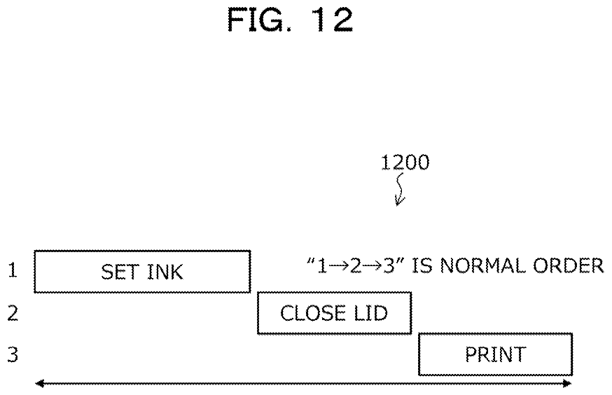

In this case, the action estimation rule provides the negation NOT of the elemental action “look right and left”, and the logical product AND of the negation NOT and the elemental action “cross at a crosswalk” as the logical conditions, for example. The action estimation rule indicates that, for example, the time point of the start of the elemental action “cross at a crosswalk” corresponds to the time point of the start of the target action “Not confirm right and left & cross at a crosswalk”. The action estimation rule indicates that, for example, the time point of the end of the elemental action “cross at a crosswalk” corresponds to the time point of the end of the target action “Not confirm right and left & cross at a crosswalk”. Next, description proceeds to FIG. 12.

As illustrated in FIG. 12, for example, it is conceivable that the target action is formed by an elemental action “set ink”, an elemental action “close the lid”, and an elemental action “print”. For example, as illustrated by reference numeral 1200, in a case where the elemental action “set ink”, the elemental action “close the lid”, and the elemental action “print” are performed in order, a target action “set ink and print” will be performed.

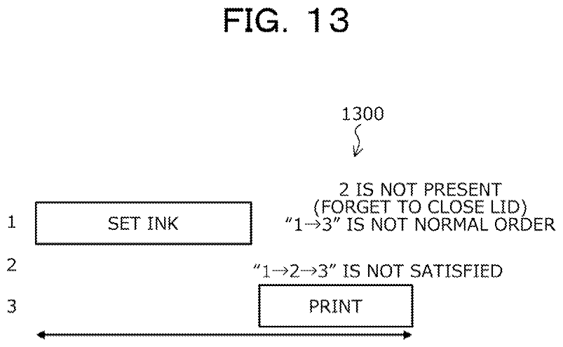

In this case, the action estimation rule provides, for example, the order condition of the elemental action “set ink”, the elemental action “close the lid”, and the elemental action “print”. The action estimation rule indicates that, for example, the time point of the start of the elemental action “set ink” corresponds to the time point of the start of the target action “set ink and print”. The action estimation rule indicates that, for example, the time point of the end of the elemental action “print” corresponds to the time point of the end of the target action “set ink and print”. Next, the description moves onto FIG. 13, and an abnormal case in which the order condition is not satisfied and the target action “set ink and print” has not been normally performed will be described.

In FIG. 13, as illustrated by reference numeral 1300, in a case where the elemental action “close the lid” is not performed even when the elemental action “set ink” and the elemental action “print” have been performed in order, it is treated that the target action “set ink and print” is not performed. In this way, various target actions can be defined.

### First Motion Example of Information Processing Device 100

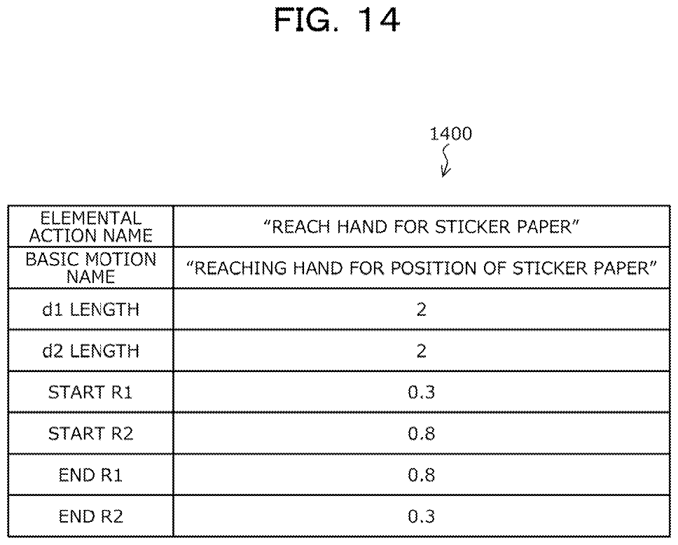

Next, a first motion example of the information processing device 100 will be described with reference to FIGS. 14 to 29. First, an example of the time series analysis rule for recognizing the time point of the start or the end of the elemental action in the first motion example will be described with reference to FIGS. 14 to 16. In the following description, the target action is assumed to be “stick the sticker on the box”.

FIGS. 14 to 16 are explanatory diagrams illustrating an example of the time series analysis rule in the first motion example. For example, FIG. 14 illustrates a time series analysis rule 1400 that defines how to specify the time point of the start and the time point of the end of the elemental action “reach the hand for the sticker paper” corresponding to a basic motion “reaching the hand for the position of the sticker paper”.

The time series analysis rule 1400 includes, for example, an elemental action name of the elemental action “reach the hand for the sticker paper”. The time series analysis rule 1400 includes, for example, a basic motion name of the basic motion “reaching the hand for the position of the sticker paper” corresponding to the elemental action “reach the hand for the sticker paper”.

The time series analysis rule 1400 includes, for example, the d1 length indicating the length of a first half period of the two consecutive periods set for specifying the time point of the start or the end of the elemental action “reach the hand for the sticker paper”. The time series analysis rule 1400 includes, for example, the d2 length indicating the length of a latter half period of the two consecutive periods set for specifying the time point of the start or the end of the elemental action “reach the hand for the sticker paper”.

The d1 length for specifying the start of the elemental action and the d1 length for specifying the end of the elemental action may be different. The d2 length for specifying the start of the elemental action and the d2 length for specifying the end of the elemental action may be different.

The time series analysis rule 1400 includes, for example, start R1 indicating the first threshold to be compared with the ratio of frames of the basic motion “reaching the hand for the position of the sticker paper” in the first half period in order to specify the time point of the start of the elemental action “reach the hand for the sticker paper”. The time series analysis rule 1400 includes, for example, start R2 indicating the second threshold to be compared with the ratio of frames of the basic motion “reaching the hand for the position of the sticker paper” in the latter half period in order to specify the time point of the start of the elemental action “reach the hand for the sticker paper”.

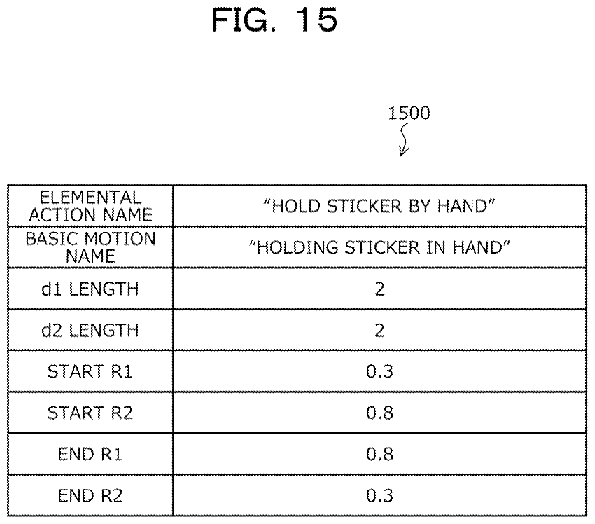

The time series analysis rule 1400 includes, for example, end R1 indicating the third threshold to be compared with the ratio of frames of the basic motion “reaching the hand for the position of the sticker paper” in the first half period in order to specify the time point of the end of the elemental action “reach the hand for the sticker paper”. The time series analysis rule 1400 includes, for example, end R2 indicating the fourth threshold to be compared with the ratio of frames of the basic motion “reaching the hand for the position of the sticker paper” in the latter half period in order to specify the time point of the end of the elemental action “reach the hand for the sticker paper”. Next, description proceeds to FIG. 15.

For example, FIG. 15 illustrates a time series analysis rule 1500 that defines how to specify the time point of the start and the time point of the end of the elemental action “hold the sticker by hand” corresponding to a basic motion “holding the sticker in the hand”

The time series analysis rule 1500 includes, for example, the elemental action name of the elemental action “hold the sticker by hand”. The time series analysis rule 1500 includes, for example, the basic motion name of the basic motion “holding the sticker in the hand” corresponding to the elemental action “hold the sticker by hand”.

The time series analysis rule 1500 includes, for example, the d1 length indicating the length of the first half period of the two consecutive periods set for specifying the time point of the start or the end of the elemental action “hold the sticker by hand”. The time series analysis rule 1500 includes, for example, the d2 length indicating the length of the latter half period of the two consecutive periods set for specifying the time point of the start or the end of the elemental action “hold the sticker by hand”.

The time series analysis rule 1500 includes, for example, start R1 indicating the first threshold to be compared with the ratio of frames of the basic motion “holding the sticker in the hand” in the first half period in order to specify the time point of the start of the elemental action “hold the sticker by hand”. The time series analysis rule 1500 includes, for example, start R2 indicating the second threshold to be compared with the ratio of frames of the basic motion “holding the sticker in the hand” in the latter half period in order to specify the time point of the start of the elemental action “hold the sticker by hand”.

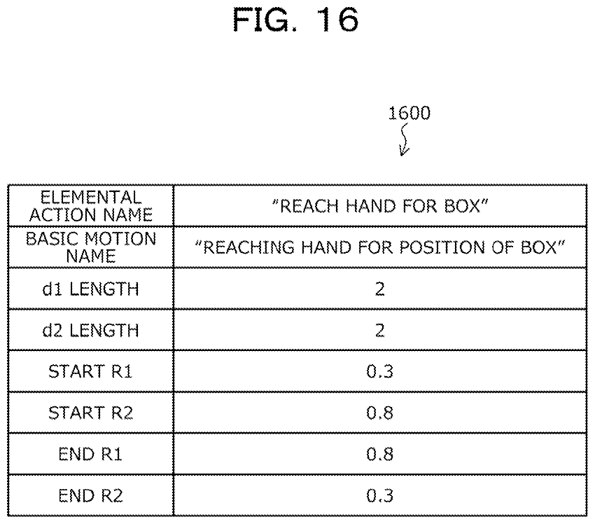

The time series analysis rule 1500 includes, for example, end R1 indicating the third threshold to be compared with the ratio of frames of the basic motion “holding the sticker in the hand” in the first half period in order to specify the time point of the end of the elemental action “hold the sticker by hand”. The time series analysis rule 1500 includes, for example, end R2 indicating the fourth threshold to be compared with the ratio of frames of the basic motion “holding the sticker in the hand” in the latter half period in order to specify the time point of the end of the elemental action “hold the sticker by hand”. Next, description proceeds to FIG. 16.

For example, FIG. 16 illustrates a time series analysis rule 1600 that defines how to specify the time point of the start and the time point of the end of the elemental action “reach the hand for the box” corresponding to a basic motion “reach the hand for the position of the box”.

The time series analysis rule 1600 includes, for example, an elemental action name of the elemental action “reach the hand for the box”. The time series analysis rule 1600 includes, for example, a basic motion name of the basic motion “reaching the hand for the position of the box” corresponding to the elemental action “reach the hand for the box”.

The time series analysis rule 1600 includes, for example, the d1 length indicating the length of a first half period of the two consecutive periods set for specifying the time point of the start or the end of the elemental action “reach the hand for the box”. The time series analysis rule 1600 includes, for example, the d2 length indicating the length of the latter half period of the two consecutive periods set for specifying the time point of the start or the end of the elemental action “reach the hand for the box”.

The time series analysis rule 1600 includes, for example, start R1 indicating the first threshold to be compared with the ratio of frames of the basic motion “reaching the hand for the position of the box” in the first half period in order to specify the time point of the start of the elemental action “reach the hand for the box”. The time series analysis rule 1600 includes, for example, start R2 indicating the second threshold to be compared with the ratio of frames of the basic motion “reaching the hand for the position of the box” in the latter half period in order to specify the time point of the start of the elemental action “reach the hand for the box”.

The time series analysis rule 1600 includes, for example, end R1 indicating the third threshold to be compared with the ratio of frames of the basic motion “reaching the hand for the position of the box” in the first half period in order to specify the time point of the end of the elemental action “reach the hand for the box”. The time series analysis rule 1600 includes, for example, end R2 indicating the fourth threshold to be compared with the ratio of frames of the basic motion “reaching the hand for the position of the box” in the latter half period in order to specify the time point of the end of the elemental action “reach the hand for the box”. The information processing device 100 has the time series analysis rule 1400, the time series analysis rule 1500, and the time series analysis rule 1600.

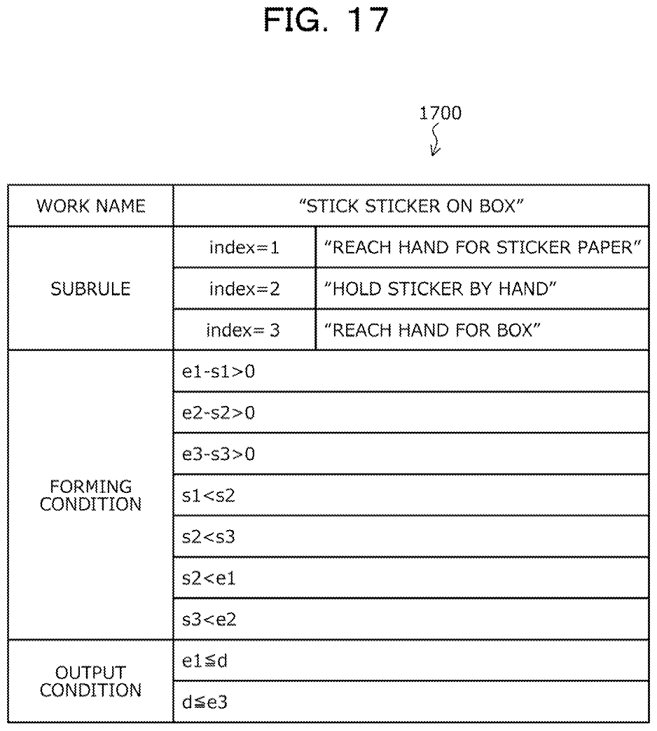

Next, an example of the action estimation rule for specifying the time in which the target action has been performed in the first motion example will be described with reference to FIG. 17.

FIG. 17 is an explanatory diagram illustrating an example of the action estimation rule in the first motion example. For example, FIG. 17 illustrates an action estimation rule 1700 that defines how to specify the time in which the target action “stick the sticker on the box” has been performed.

The action estimation rule 1700 includes, for example, a work name indicating a name of the target action “stick the sticker on the box”. The action estimation rule 1700 includes, as a subrule, the elemental action names of the elemental action “reach the hand for the sticker paper”, the elemental action “hold the sticker by hand”, and the elemental action “reach the hand for the box” related to the target action “stick the sticker on the box”, for example. Each elemental action is indexed, for example, for convenience.

The action estimation rule 1700 provides, for example, a forming condition. The forming condition is a condition for determining whether the target action is established. Being established is that the target action has been performed. The forming condition is expressed by at least either the logical condition or the order condition.

The logical condition or the order condition may be described in natural language, for example. The forming condition may be expressed by, for example, an attribute value. For example, the forming condition may be expressed by an attribute value indicating an attribute of an entity that has performed an action.

The action estimation rule 1700, for example, includes that the time point e1 of the end−the time point s1 of the start>0, regarding the elemental action “reach the hand for the sticker paper”. The action estimation rule 1700, for example, includes that the time point e2 of the end−the time point s2 of the start>0, regarding the elemental action “hold the sticker by hand”. The action estimation rule 1700, for example, includes that the time point e3 of the end−the time point s3 of the start>0, regarding the elemental action “reach the hand for the box”.

The action estimation rule 1700, for example, includes that the time point s1 of the start of the elemental action “reach the hand for the sticker paper”<the time point s2 of the start of the elemental action “hold the sticker by hand”. The action estimation rule 1700, for example, includes that the time point s2 of the start of the elemental action “hold the sticker by hand”<the time point s3 of the start of the elemental action “reach the hand for the box”.

The action estimation rule 1700, for example, includes that the time point s2 of the start of the elemental action “hold the sticker by hand”<the time point e1 of the end of the elemental action “reach the hand for the sticker paper”. The action estimation rule 1700, for example, includes that the time point s3 of the start of the elemental action “reach the hand for the box”<the time point e2 of the end of the elemental action “hold the sticker by hand”.

The action estimation rule 1700 includes, for example, an output condition that enables specification of the time d in which the target action “stick the sticker on the box” has been performed. The output condition corresponds to the output control information. The output condition may be described in natural language, for example.

For example, the action estimation rule 1700 includes “e1 d” indicating that the time d in which the target action “stick the sticker on the box” has been performed is at or after the time point e1 of the end of the elemental action “reach the hand for the sticker paper”. For example, the action estimation rule 1700 includes “d e3” indicating that the time d in which the target action “stick the sticker on the box” has been performed is at or before the time point e3 of the end of the elemental action “reach the hand for the box”. The information processing device 100 has the action estimation rule 1700.

For example, the forming condition can be set to be able to determine whether or not the target action has been established in consideration of a case where the target action fails or is interrupted, or the like. For example, the forming condition may be set to be able to determine that the target action is not established in a case where s3<e2 is satisfied and the sticker is released For example, the output condition can be set to enable accurate specification of the time in which the target action has been performed in consideration of an incidental time in which an elemental action incidental to the target action has been performed or a blank time in which no elemental action has been performed. For example, the output condition may be set such that d does not include the blank time of s2−e1 and the blank time of s3−e2. Thereby, the forming condition and the output condition enable accurate specification of the time in which the target action has been performed.

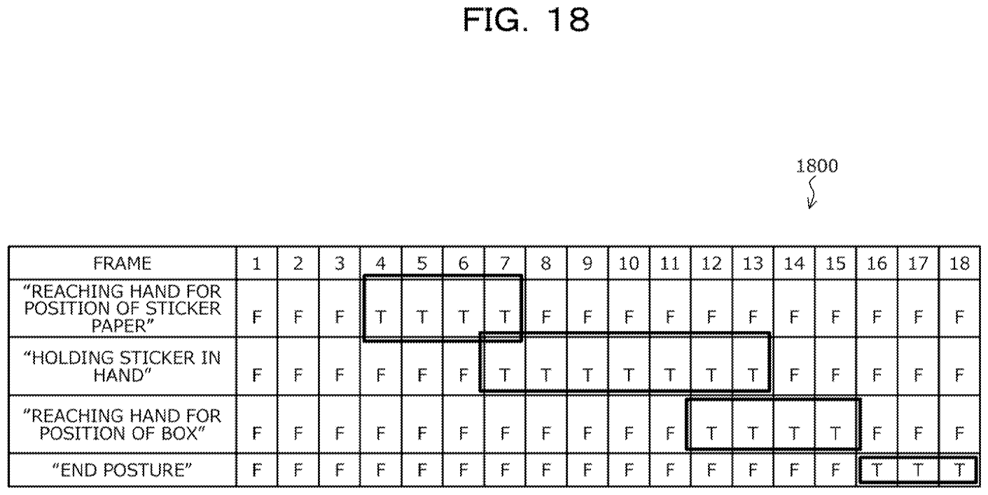

Next, an example in which the information processing device 100 recognizes the basic motion in a normal case where the target action is actually performed will be described with reference to FIG. 18. In the following description, it is assumed that various basic motions are performed by the same person. The two basic motions may be performed by persons different from each other.

FIG. 18 is an explanatory diagram illustrating an example of recognizing a basic motion in a normal case. In FIG. 18, the information processing device 100 acquires moving image data. The information processing device 100 recognizes the presence or absence of basic motions for each frame included in the moving image data, using the predetermined model. The basic motions are, for example, “reaching the hand for the position of the sticker paper”, “holding the sticker in the hand”, “reaching the hand for the position of the box”, “end posture”, and the like.

The information processing device 100 recognizes the presence or absence of each of the basic motions for each frame included in the moving image data, as illustrated in Table 1800. F in Table 1800 indicates that the basic motions are not recognized. T in Table 1800 indicates that the basic motions are recognized. In Table 1800, the frames in which the basic motions are recognized are illustrated by enclosure in thick frame.

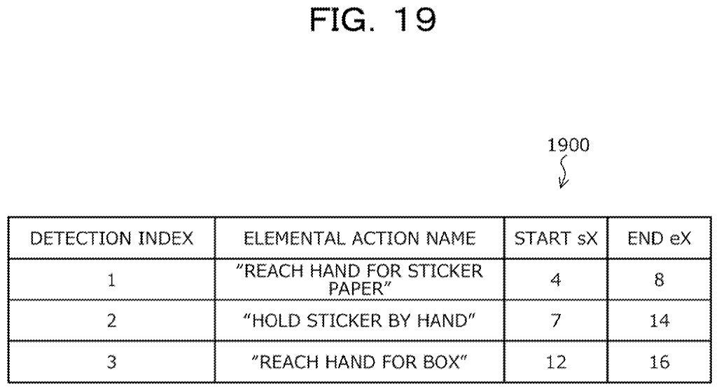

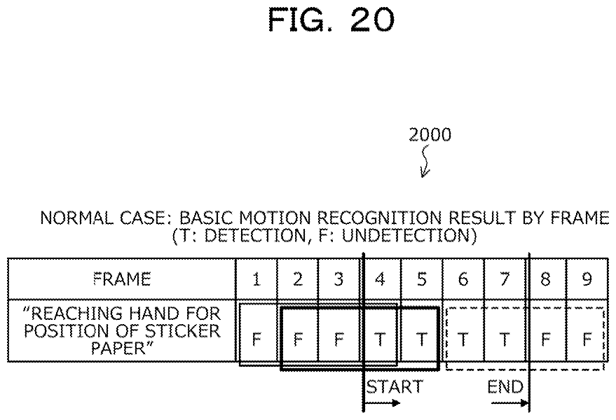

Next, an example in which the information processing device 100 recognizes the elemental action in the normal case where the target action is actually performed will be described with reference to FIGS. 19 and 20.

FIGS. 19 and 20 are explanatory diagrams illustrating examples of recognizing the elemental action in the normal case. In FIG. 19, the information processing device 100 recognizes the elemental action as illustrated in Table 1900 on the basis of the presence or absence of the basic motion for each frame illustrated in Table 1800, and specifies a time point sX of the start and a time point eX of the end of the elemental action. Next, description moves onto FIG. 20, and a specific example of specifying the time point sX of the start and the time point eX of the end of the elemental action will be described.

In FIG. 20, the information processing device 100 specifies the time point sX of the start and the time point eX of the end of the elemental action “reach the hand for the sticker paper” as illustrated by reference numeral 2000. For example, the information processing device 100 acquires the d1 length, the d2 length, the start R1, the start R2, the end R1, and the end R2 with reference to the time series analysis rule 1400. The d1 length is expressed by, for example, the number of frames. The d2 length is expressed by, for example, the number of frames.

For example, the information processing device 100 calculates the ratio of frames in which the basic motion is recognized in each period while sliding two consecutive periods from the beginning of the time series of the presence or absence of the basic motion for each frame. More specifically, for example, the information processing device 100 calculates the ratio of frames in which the basic motion is recognized in the first half period of the d1 length and the ratio of frames in which the basic motion is recognized in the latter half period of the d2 length.

More specifically, for example, in the example of FIG. 20, the information processing device 100 is assumed to calculate the ratio of frames in which the basic motion is recognized in the first half period including frames 2 and 3 and the ratio of frames in which the basic motion is recognized in the latter half period including frames 4 and 5.

For example, the information processing device 100 determines whether the ratio of frames in which the basic motion is recognized in the first half period is equal to or less than the start R1. For example, the information processing device 100 determines whether the ratio of frames in which the basic motion is recognized in the latter half period is equal to or larger than the start R2. For example, the information processing device 100 specifies the beginning of the latter half period as the time point of the start of the elemental action, in a case where the ratio of frames in which the basic motion is recognized in the first half period is equal to or less than the start R1, and the ratio of frames in which the basic motion is recognized in the latter half period is equal to or larger than the start R2.

More specifically, for example, in the example of FIG. 20, the information processing device 100 specifies the frame 4 that is the beginning of the latter half period as the time point sX of the start of the elemental action “reach the hand for the sticker paper”. Similarly, more specifically, for example, the information processing device 100 specifies the frame 8 as the time point eX of the end of the elemental action “reach the hand for the sticker paper”. For example, since the elemental action “reach the hand for the sticker paper” is determined to end at the end of the frame 7, the time point eX of the end of the elemental action “reach the hand for the sticker paper” is the time of the end of the frame 7=the time of the beginning of the frame 8, and is specified as the frame 8.

Similarly, the information processing device 100 specifies the time point of the start sX and the time point of the end eX of the elemental action “holding the sticker by hand”. Similarly, the information processing device 100 specifies the time point of the start sX and the time point of the end eX of the elemental action “reach the hand for the box”.

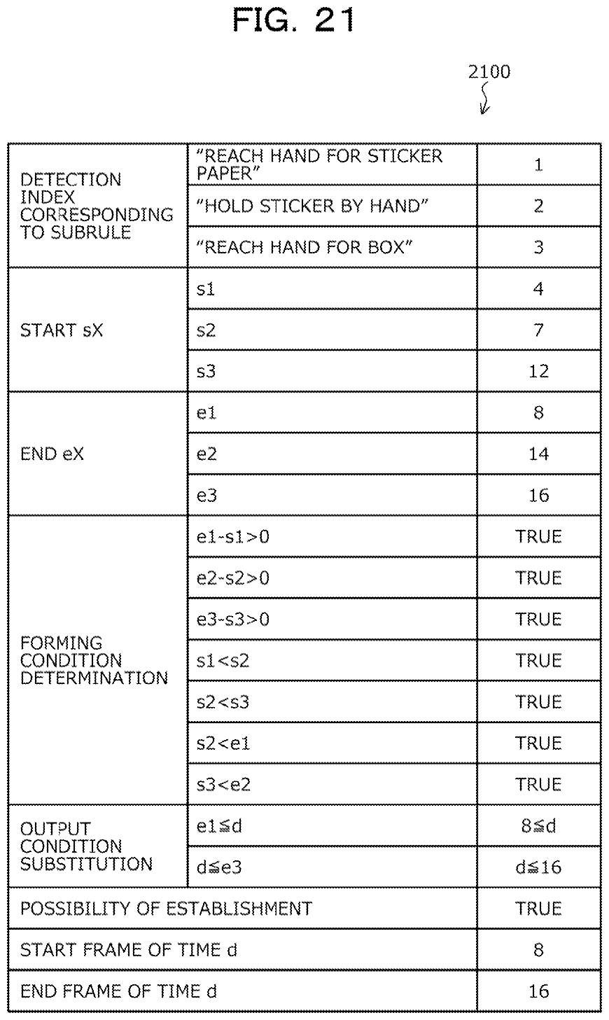

Next, an example in which the information processing device 100 specifies the time in which the target action has been performed after correctly recognizing that the target action has been performed in the normal case where the target action has actually been performed will be described with reference to FIG. 21.

FIG. 21 is an explanatory diagram illustrating an example of specifying the time in which the target action has been performed in the normal case. In FIG. 21, the information processing device 100 sets the time point sX of the start and the time point eX of the end of the i-th elemental action to a time point si of the start and a time point ei of the end, as illustrated in Table 2100. i corresponds to an index of the elemental action.

The information processing device 100 refers to the action estimation rule 1700 and determines whether each forming condition is TRUE or FALSE. TRUE indicates that the forming condition is satisfied. FALSE indicates that the forming condition is not satisfied.

As illustrated in Table 2100, the information processing device 100 determines that the forming condition of the time point e1 of the end−the time point s1 of the start>0 is TRUE for the elemental action “reach the hand for the sticker paper”. As illustrated in Table 2100, the information processing device 100 determines that the forming condition of the time point e2 of the end−the time point s2 of the start>0 is TRUE for the elemental action “hold the sticker by hand”. As illustrated in Table 2100, the information processing device 100 determines that the forming condition of the time point e3 of the end−the time point s3 of the start>0 is TRUE for the elemental action “reach the hand for the box”.

As illustrated in Table 2100, the information processing device 100 determines that the forming condition of the time point s1 of the start of the elemental action “reach the hand for the sticker paper”<the time point s2 of the start of the elemental action “hold the sticker by hand” is TRUE. As illustrated in Table 2100, the information processing device 100 determines that the forming condition of the time point s2 of the start of the elemental action “hold the sticker by hand”<the time point s3 of the start of the elemental action “reach the hand for the box” is TRUE.

As illustrated in Table 2100, the information processing device 100 determines that the forming condition of the time point s2 of the start of the elemental action “hold the sticker by hand”<the time point e1 of the end of the elemental action “reach the hand for the sticker paper” is TRUE. As illustrated in Table 2100, the information processing device 100 determines that the forming condition of the time point s3 of the start of the elemental action “reach the hand for the box”<the time point e2 of the end of the elemental action “hold the sticker by hand” is TRUE.

As illustrated in Table 2100, since all the forming conditions are TRUE, the possibility of establishment of the target action is TRUE, and the information processing device 100 determines that the target action has been performed. TRUE indicates that the target action is established. Thereby, the information processing device 100 can correctly recognize that the target action has been performed.

Since the target action is established, the information processing device 100 refers to the action estimation rule 1700 and specifies the time in which the output condition is satisfied as the time d in which the target action has been performed. As illustrated in Table 2100, the information processing device 100 specifies the frame 8 the time d in which the target action has been performed the frame 16. As illustrated in Table 2100, the information processing device 100 stores the frame number 8 indicating the time point of the start of the time d in which the target action has been performed and the frame number 16 indicating the time point of the end. The information processing device 100 outputs the frame number 8 indicating the time point of the start of the time d in which the target action has been performed and the frame number 16 indicating the time point of the end in a referrable manner from the user.

Thereby, the information processing device 100 can accurately specify the time in which the target action has been performed. For example, the information processing device 100 can accurately specify the time in which the target work has been performed in consideration of an incidental time in which an elemental action incidental to the target action has been performed or a blank time in which no elemental action has been performed on the basis of the forming condition and the output condition.

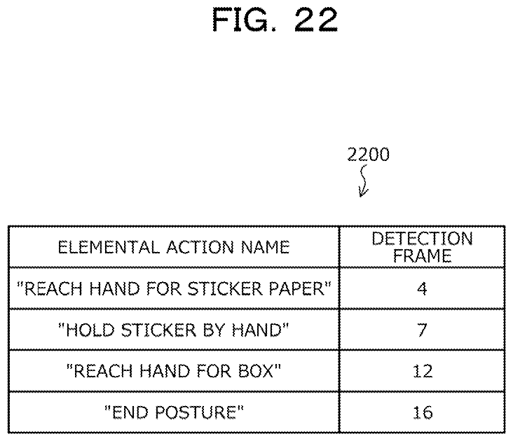

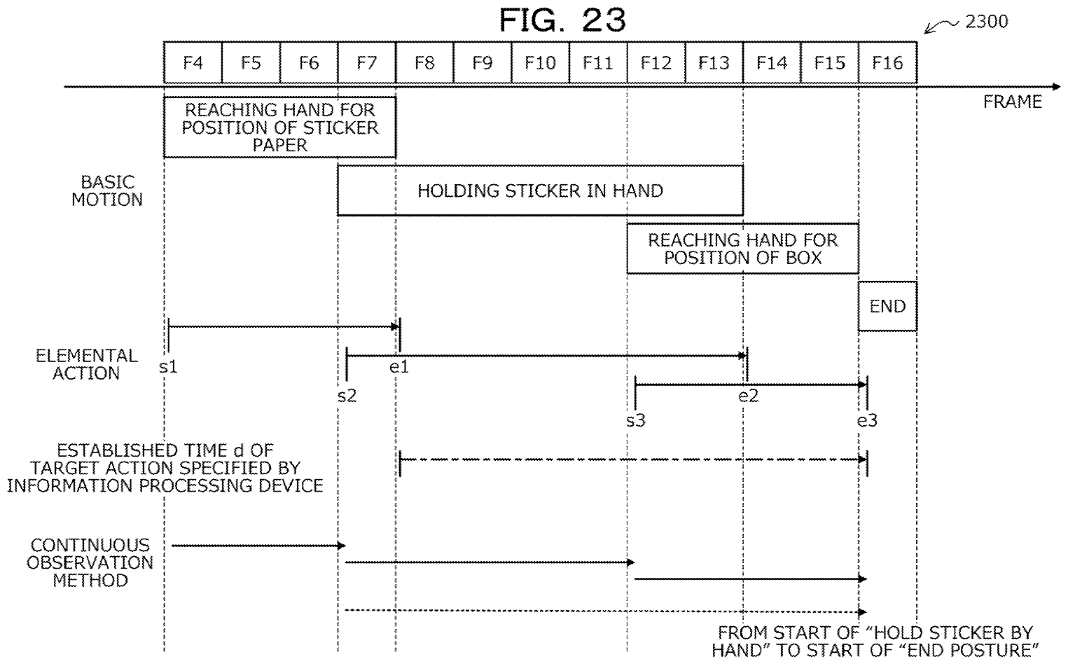

Next, comparative examples with an existing method in a normal case will be described with reference to FIGS. 22 and 23. The existing method corresponds to a continuous observation method. The existing method is, for example, a method of specifying the time from the time point of the start of the elemental action “hold the sticker by hand” to the time point of the start of the elemental action “end posture” as the time in which the target action has been performed.

FIGS. 22 and 23 are explanatory diagrams illustrating comparative examples with an existing method in the normal case. As illustrated in Table 2200 of FIG. 22, the existing method specifies the time point of the start=4 of the elemental action “reach the hand for the sticker paper”. The existing method specifies the time point of the start=7 of the elemental action “hold the sticker by hand”. The existing method specifies the time point of the start=12 of the elemental action “reach the hand for the box”. The existing method specifies the time point of the start=16 of the elemental action “end posture”. The existing method specifies the time from the time point of the start=7 of the elemental action “hold the sticker by hand” to the time point of the start=16 of the elemental action “end posture” as the time in which the target action has been performed. Next, description proceeds to FIG. 23.

In the example of FIG. 23, the target action is defined as an action performed after the sticker is collected from the position of the sticker paper. As illustrated in graph 2300, the information processing device 100 can correctly specify the time from the time point of the end of the elemental action “reach the hand for the sticker paper” to the time point of the end of the elemental action “reach the hand for the position of the box” as the time d in which the target action has been performed according to the above-described definition. Furthermore, the information processing device 100 can correctly specify the time d in which the target action has been performed, from which the blank time has been removed, even if the blank time exists after the elemental action “reach the hand for the position of the box” to the time point of the start of the elemental action “end posture”.

Meanwhile, as illustrated in graph 2300, the existing method specifies the time from the time point of the start of the elemental action “reach the hand for the sticker paper” to the time point of the start of the elemental action “end posture” as the time d in which the target action has been performed, contrary to the above-described definition. Furthermore, the existing method specifies the time d in which the target action including the blank time has been performed, if the blank time exists after the elemental action “reach the hand for the position of the box” to the time point of the start of the elemental action “end posture”. In this way, the information processing device 100 can more accurately specify the time d in which the target action has been performed, as compared with the existing method.

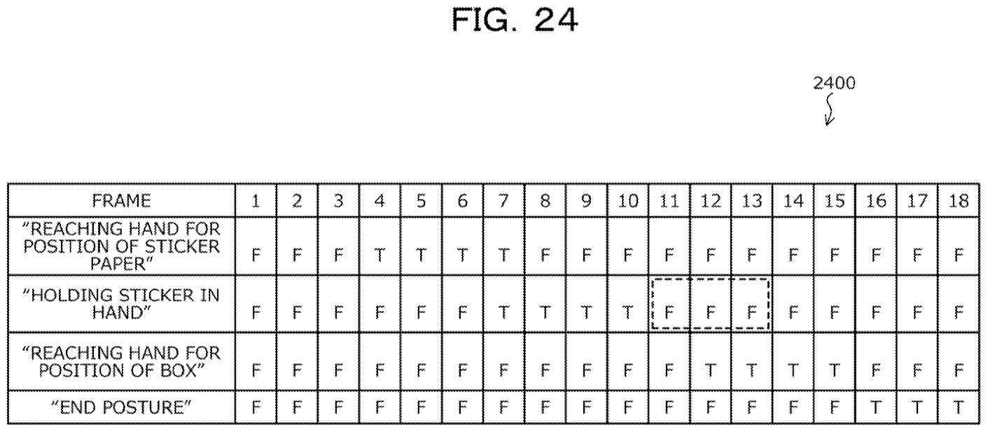

Next, an example of recognizing the basic motion in an abnormal case in which the target action has not been performed will be described with reference to FIG. 24.

FIG. 24 is an explanatory diagram illustrating an example of recognizing a basic motion in an abnormal case. In FIG. 24, the information processing device 100 acquires the moving image data. The information processing device 100 recognizes the presence or absence of basic motions for each frame included in the moving image data, using the predetermined model. The basic motions are, for example, “reaching the hand for the position of the sticker paper”, “holding the sticker in the hand”, “reaching the hand for the position of the box”, “end posture”, and the like.

The information processing device 100 recognizes the presence or absence of each of the basic motions for each frame included in the moving image data, as illustrated in Table 2400. F in Table 2400 indicates that the basic motions are not recognized. T in Table 2400 indicates that the basic motions are recognized. In Table 2400, the frames in which the basic motion has not been recognized are illustrated by enclosure in broken-line frame, unlike the normal case.

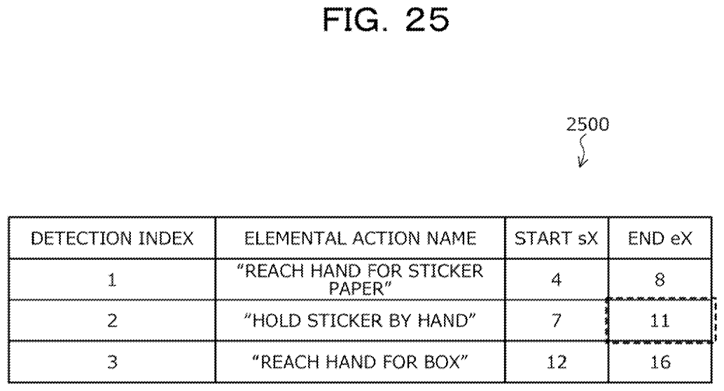

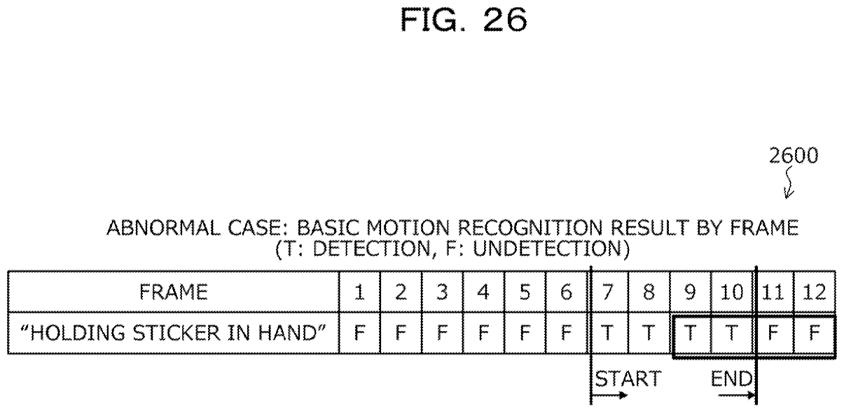

Next, an example in which the information processing device 100 recognizes the elemental action in an abnormal case where the target action is not performed will be described with reference to FIGS. 25 and 26.

FIGS. 25 and 26 are explanatory diagrams illustrating examples of recognizing an elemental action in the abnormal case. In FIG. 25, the information processing device 100 recognizes the elemental action as illustrated in Table 2500 on the basis of the presence or absence of the basic motion for each frame illustrated in Table 2400, and specifies the time point sX of the start and the time point eX of the end of the elemental action. In Table 2500, the end eX=11 as illustrated by the broken-line frame, unlike the normal case. Next, description moves onto FIG. 26, and a specific example of specifying the time point sX of the start and the time point eX of the end of the elemental action will be described.

In FIG. 26, the information processing device 100 specifies the time point sX of the start and the time point eX of the end of the elemental action “reach the hand for the sticker paper” as illustrated by reference numeral 2600. Similarly, the information processing device 100 specifies the time point of the start sX and the time point of the end eX of the elemental action “holding the sticker by hand”. Similarly, the information processing device 100 specifies the time point of the start sX and the time point of the end eX of the elemental action “reach the hand for the box”.

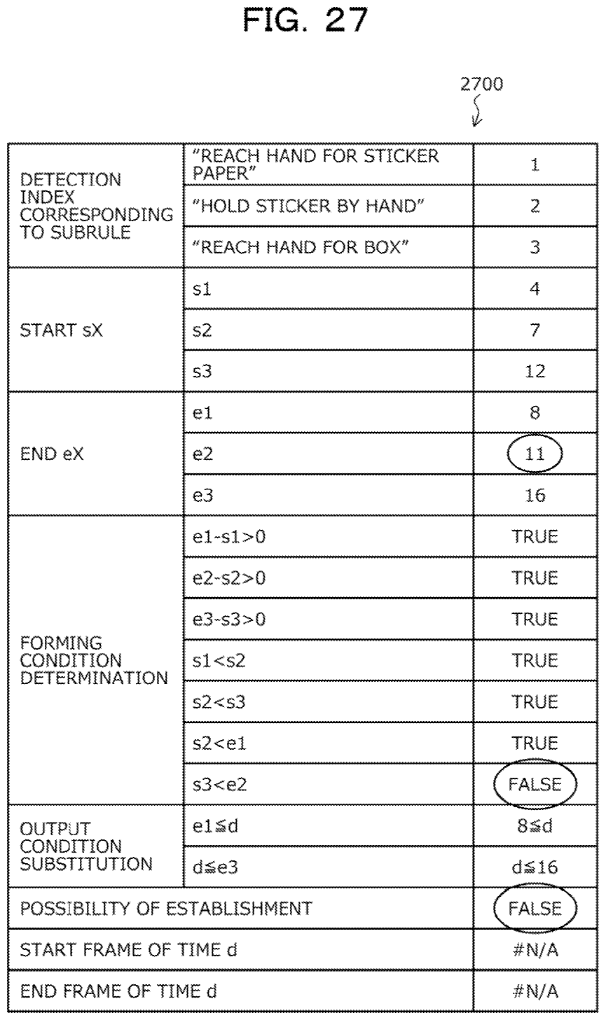

Next, an example in which the information processing device 100 recognizes that the target action is not performed in the abnormal case where the target action is not performed will be described with reference to FIG. 27.

FIG. 27 is an explanatory diagram illustrating an example of recognizing that the target action is not performed in the abnormal case. In FIG. 27, the information processing device 100 sets the time point sX of the start and the time point eX of the end of the i-th elemental action to a time point si of the start and a time point ei of the end, as illustrated in Table 2700. i corresponds to an index of the elemental action. The time point of the end e2=11, unlike the normal case.

The information processing device 100 refers to the action estimation rule 1700 and determines whether each forming condition is TRUE or FALSE. TRUE indicates that the forming condition is satisfied. FALSE indicates that the forming condition is not satisfied.

As illustrated in Table 2700, the information processing device 100 determines that the forming condition of the time point e1 of the end−the time point s1 of the start>0 is TRUE for the elemental action “reach the hand for the sticker paper”. As illustrated in Table 2700, the information processing device 100 determines that the forming condition of the time point e2 of the end−the time point s2 of the start>0 is TRUE for the elemental action “hold the sticker by hand”. As illustrated in Table 2700, the information processing device 100 determines that the forming condition of the time point e3 of the end−the time point s3 of the start>0 is TRUE for the elemental action “reach the hand for the box”

As illustrated in Table 2700, the information processing device 100 determines that the forming condition of the time point s1 of the start of the elemental action “reach the hand for the sticker paper”<the time point s2 of the start of the elemental action “hold the sticker by hand” is TRUE. As illustrated in Table 2700, the information processing device 100 determines that the forming condition of the time point s2 of the start of the elemental action “hold the sticker by hand”<the time point s3 of the start of the elemental action “reach the hand for the box” is TRUE.

As illustrated in Table 2700, the information processing device 100 determines that the forming condition of the time point s2 of the start of the elemental action “hold the sticker by hand”<the time point e1 of the end of the elemental action “reach the hand for the sticker paper” is TRUE. As illustrated in Table 2700, the information processing device 100 determines that the forming condition of the time point s3 of the start of the elemental action “reach the hand for the box”<the time point e2 of the end of the elemental action “hold the sticker by hand” is FALSE, which is different from the normal case.

As illustrated in Table 2700, the information processing device 100 determines that the possibility of establishment of the target action is FALSE and the target action has not been performed because the forming condition of FALSE exists. FALSE indicates that the target action is not established. Thereby, the information processing device 100 can correctly recognize that the target action has not been performed.

The information processing device 100 does not specify the time d in which the target action has been performed because the target action is not established. With this configuration, the information processing device 100 can avoid erroneously specifying the time in which the target action has been performed. For example, the information processing device 100 can avoid specifying the time when the target work has been performed if the target action is not established based on the forming condition.

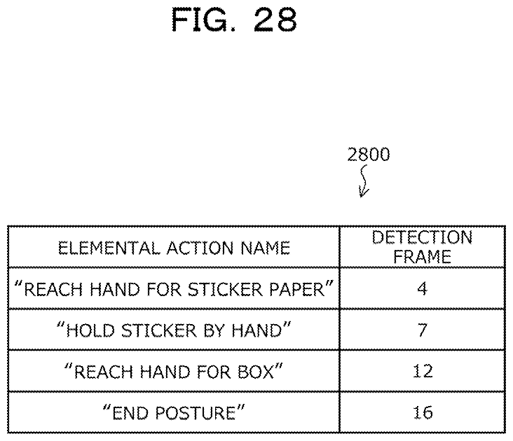

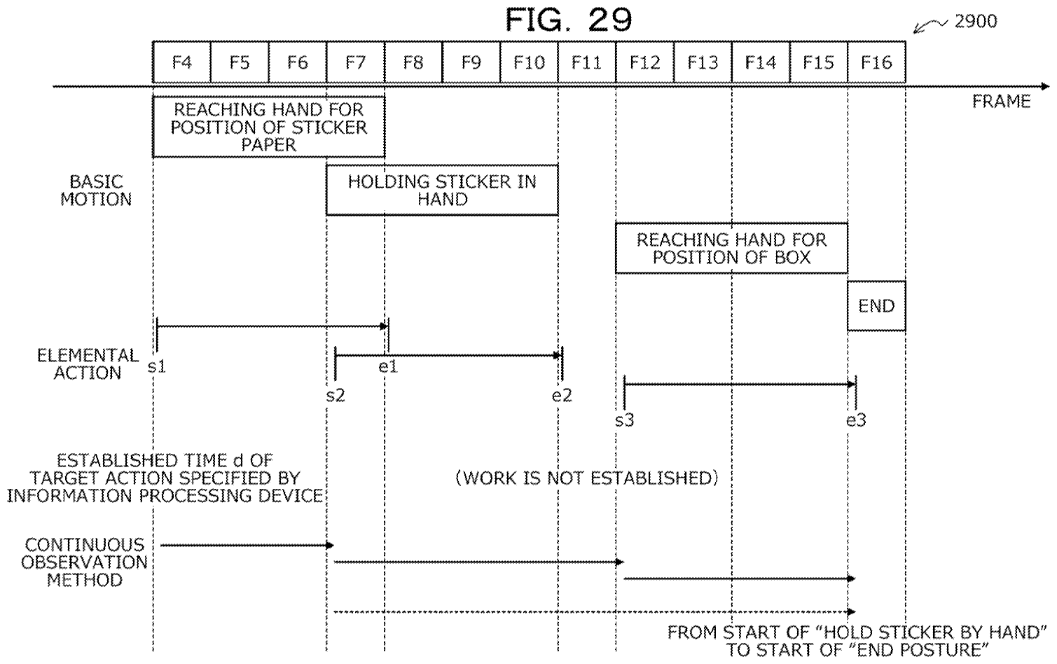

Next, comparative examples with an existing method in an abnormal case will be described with reference to FIGS. 28 and 29. The existing method corresponds to a continuous observation method. The existing method is, for example, a method of specifying the time from the time point of the start of the elemental action “hold the sticker by hand” to the time point of the start of the elemental action “end posture” as the time in which the target action has been performed.

FIGS. 28 and 29 are explanatory diagrams illustrating comparative examples with an existing method in the abnormal case. As illustrated in Table 2800 of FIG. 28, the existing method specifies the time point of the start=4 of the elemental action “reach the hand for the sticker paper”. The existing method specifies the time point of the start=7 of the elemental action “hold the sticker by hand”. The existing method specifies the time point of the start=12 of the elemental action “reach the hand for the box”. The existing method specifies the time point of the start=16 of the elemental action “end posture”. The existing method specifies the time from the time point of the start=7 of the elemental action “hold the sticker by hand” to the time point of the start=16 of the elemental action “end posture” as the time in which the target action has been performed. Next, description proceeds to FIG. 29.

In the example of FIG. 29, the target action is defined as not being established. As illustrated in Graph 2900, the information processing device 100 can determine that the target action has not been performed and can prevent erroneous specification of the time d in which the target action has been performed according to the above-described definition.

Meanwhile, as illustrated in graph 2900, the existing method specifies the time from the time point of the start of the elemental action “reach the hand for the sticker paper” to the time point of the start of the elemental action “end posture” as the time d in which the target action has been performed, contrary to the above-described definition. In this way, the information processing device 100 can specify the time d in which the target action has been performed only in the case where the target action has been performed after correctly determining whether the target action has been performed, as compared with the existing method.

### Second Motion Example of Information Processing Device 100

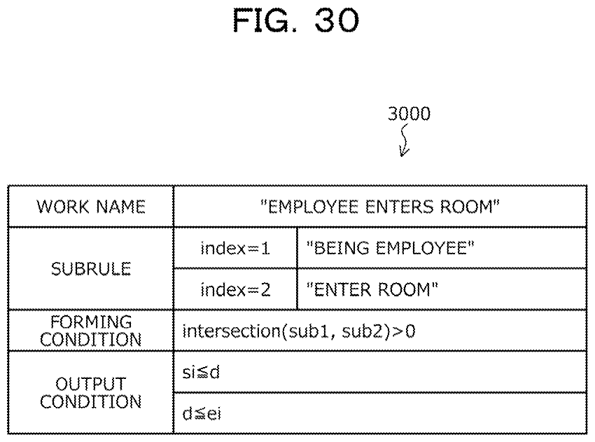

Next, a second motion example of the information processing device 100 will be described with reference to FIGS. 30 to 32. The above-described first motion example corresponds to the case where the forming condition defined in the action estimation rule is expressed by the order condition. In contrast, the second motion example corresponds to the case where the forming condition defined in the action estimation rule is expressed by the logical condition. For example, the second motion example corresponds to the case where the forming condition is expressed by the logical condition using the logical product AND.

First, an example of the action estimation rule for specifying the time in which the target action has been performed in the second motion example will be described with reference to FIG. 30. In the following description, the target action is assumed to be “an employee enters the room”.

FIG. 30 is an explanatory diagram illustrating an example of the action estimation rule in a second motion example. For example, FIG. 30 illustrates an action estimation rule 3000 that defines how to specify the time in which a target action “an employee enters the room” has been performed.

The action estimation rule 3000 includes, for example, a work name indicating a name of the target action “an employee enters the room”. The action estimation rule 3000 includes, for example, as subrules, elemental action names of an elemental action “being an employee” and an elemental action “enter the room” related to the target action “an employee enters the room”. Each elemental action is indexed, for example, for convenience.

The action estimation rule 3000 indicates, for example, a forming condition. The forming condition is a condition for determining whether the target action is established. Being established is that the target action has been performed. The forming condition is expressed by at least either the logical condition or the order condition.

The action estimation rule 3000, for example, includes intersection (sub1, sub2)>0. sub1 indicates the elemental action “being an employee” of a subrule. sub2 indicates the elemental action “enter the room” of a subrule. intersection (sub1, sub2) indicates the time in which the elemental action “being an employee” and the elemental action “enter the room” have been established at the same time, and intersection (sub1, sub2)>0 indicates a conditional expression in which there is the time in which the elemental action “being an employee” and the elemental action “enter the room” have been established at the same time.

The action estimation rule 3000 includes, for example, an output condition that enables specification of the time d in which the target action “an employee enters the room” has been performed. The output condition corresponds to the output control information.

For example, the action estimation rule 3000 indicates that the time d in which the target action “an employee enters the room” has been performed is at or after si. si indicates the time point of the start in the time in which the elemental action “being an employee” and the elemental action “enter the room” are established at the same time.

For example, the action estimation rule 3000 indicates that the time d in which the target action “an employee enters the room” has been performed is at or before ei. ei indicates the time point of the end in the time in which the elemental action “being an employee” and the elemental action “enter the room” are established at the same time. Thereby, the forming condition and the output condition enable accurate specification of the time in which the target action has been performed.

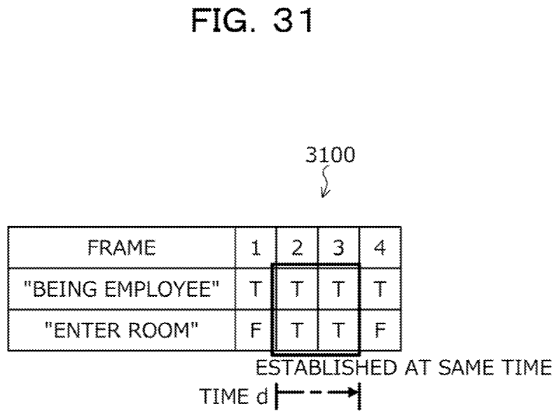

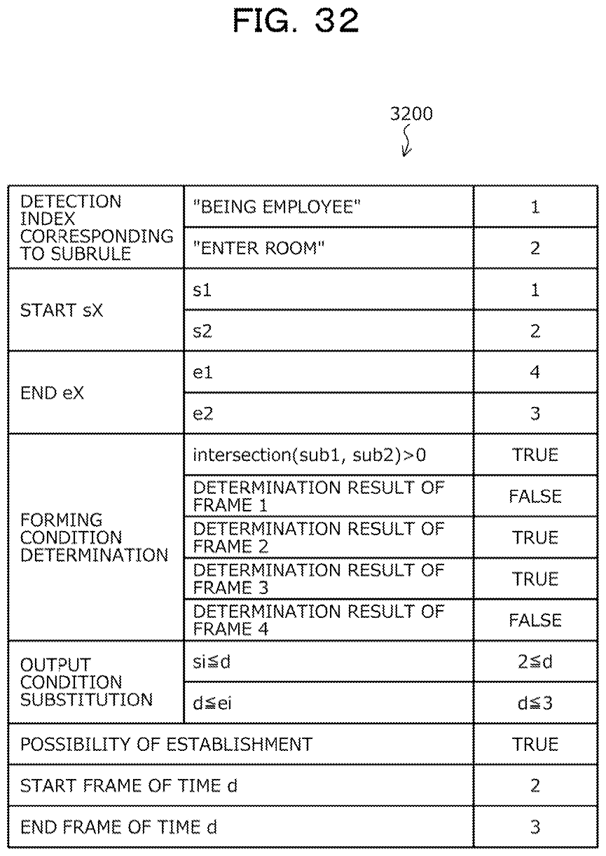

Next, an example in which the information processing device 100 specifies the time in which the target action has been performed in the second motion example will be described with reference to FIGS. 31 and 32.

FIGS. 31 and 32 are explanatory diagrams illustrating examples of specifying the time in which the target action has been performed in the second motion example. In FIG. 31, the information processing device 100 recognizes the elemental action as illustrated in Table 3100 on the basis of the presence or absence of the basic motion for each frame, and specifies the time point sX of the start and the time point eX of the end of the elemental action.

The information processing device 100 specifies, for example, the time point sX of the start and the time point eX of the end of the elemental action “being an employee” with reference to the time series analysis rule of the elemental action “being an employee”. The information processing device 100 specifies, for example, the time point sX of the start and the time point eX of the end of the elemental action “enter the room” with reference to the time series analysis rule of the elemental action “enter the room”.

The information processing device 100 specifies the time in which the elemental action “being an employee” and the elemental action “enter the room” are established at the same time as the time in which the target action has been performed. Next, the description moves onto FIG. 32, and the information processing device 100 specifying the time in which the target action has been performed will be described.

The information processing device 100 sets the time point sX of the start and the time point eX of the end of the x-th elemental action to a time point sx of the start and a time point ex of the end, as illustrated in Table 3200. x corresponds to an index of the elemental action.

The information processing device 100 refers to the action estimation rule 1700 and determines whether the forming condition is TRUE or FALSE. TRUE indicates that the forming condition is satisfied. FALSE indicates that the forming condition is not satisfied. Furthermore, the information processing device 100 determines whether the forming condition is TRUE or FALSE for each frame.

As illustrated in Table 3200, the information processing device 100 determines that the forming condition of intersection (sub1, sub2)>0 is TRUE as a whole. As illustrated in Table 3200, the information processing device 100 determines whether or not the forming condition of intersection (sub1, sub2)>0 is TRUE for each frame.

As illustrated in Table 3200, since the forming condition is TRUE as a whole, the possibility of establishment of the target action is TRUE, and the information processing device 100 determines that the target action has been performed. TRUE indicates that the target action is established. Thereby, the information processing device 100 can correctly recognize that the target action has been performed.

Since the target action is established, the information processing device 100 refers to the action estimation rule 1700 and specifies the time in which the output condition is satisfied as the time d in which the target action has been performed. As illustrated in Table 3200, the information processing device 100 specifies the frame 2 the time d in which the target action has been performed the frame 3.

As illustrated in Table 3200, the information processing device 100 stores the frame number 2 indicating the time point of the start of the time d in which the target action has been performed and the frame number 3 indicating the time point of the end. The information processing device 100 outputs the frame number 2 indicating the time point of the start of the time d in which the target action has been performed and the frame number 3 indicating the time point of the end in a referrable manner from the user.

Thereby, the information processing device 100 can accurately specify the time in which the target action has been performed. For example, the information processing device 100 can accurately specify the time in which the target work has been performed in consideration of an incidental time in which an elemental action incidental to the target action has been performed or a blank time in which no elemental action has been performed on the basis of the forming condition and the output condition.

### Third Motion Example of Information Processing Device 100

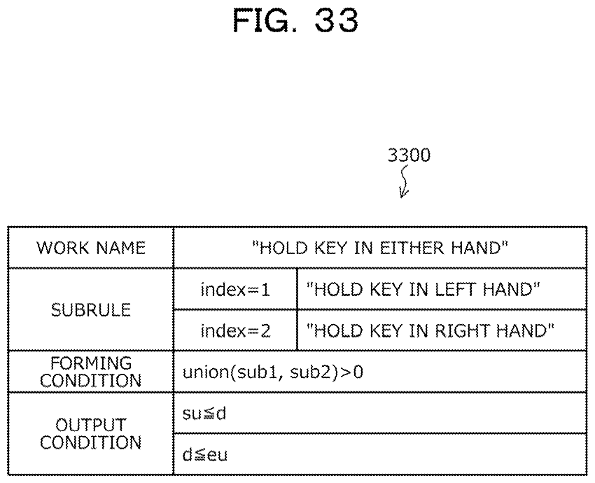

Next, a third motion example of the information processing device 100 will be described with reference to FIGS. 33 to 35. The above-described first motion example corresponds to the case where the forming condition defined in the action estimation rule is expressed by the order condition. In contrast, the third motion example corresponds to the case where the forming condition defined in the action estimation rule is expressed by the logical condition. For example, the third motion example corresponds to the case where the forming condition is expressed by the logical condition using the logical sum OR.

First, an example of the action estimation rule for specifying the time in which the target action has been performed in the third motion example will be described with reference to FIG. 33. In the following description, the target action is assumed to be “hold a key in either hand”.

FIG. 33 is an explanatory diagram illustrating an example of an action estimation rule in the third motion example. For example, FIG. 33 illustrates an action estimation rule 3300 that defines how to specify the time in which the target action “hold a key in either hand” has been performed.

The action estimation rule 3300 includes, for example, a work name indicating a name of the target action “hold a key in either hand”. The action estimation rule 3300 includes, for example, as subrules, elemental action names of an elemental action “hold a key in the left hand” and an elemental action “hold a key in the right hand” related to the target action “hold a key in either hand”. Each elemental action is indexed, for example, for convenience.

The action estimation rule 3300 indicates, for example, a forming condition. The forming condition is a condition for determining whether the target action is established. Being established is that the target action has been performed. The forming condition is expressed by at least either the logical condition or the order condition.

The action estimation rule 3300, for example, includes union (sub1, sub2)>0. sub1 indicates the elemental action “hold a key in the left hand” of a subrule. sub2 indicates the elemental action “hold a key in the right hand” of a subrule. union (sub1, sub2) indicates the time in which at least one of the elemental action “hold a key in the left hand” and the elemental action “hold a key in the right hand” has been established, and union (sub1, sub2)>0 indicates a conditional expression in which there is the time in which at least one of the elemental action “hold a key in the left hand” and the elemental action “hold a key in the right hand” is established.

The action estimation rule 3300 includes, for example, an output condition that enables specification of the time d in which the target action “hold a key in either hand” has been performed. The output condition corresponds to the output control information.

For example, the action estimation rule 3300 indicates that the time d in which the target action “hold a key in either hand” has been performed is at or after su. su indicates the time point of the start in the time in which at least one of the elemental action “hold a key in the left hand” and the elemental action “hold a key in the right hand” is established.

For example, the action estimation rule 3300 indicates that the time d in which the target action “hold a key in either hand” has been performed is at or before eu. eu indicates the time point of the end in the time in which at least one of the elemental action “hold a key in the left hand” and the elemental action “hold a key in the right hand” is established. Thereby, the forming condition and the output condition enable accurate specification of the time in which the target action has been performed.

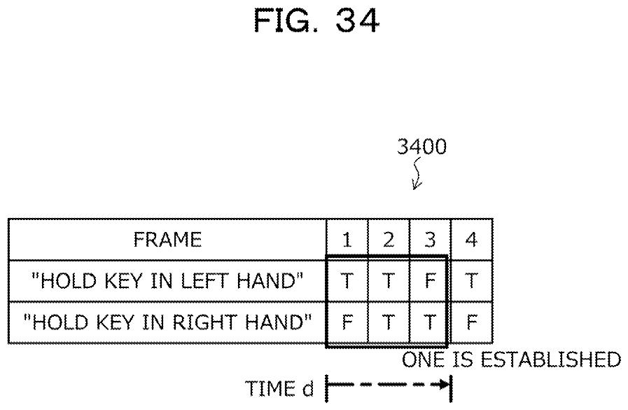

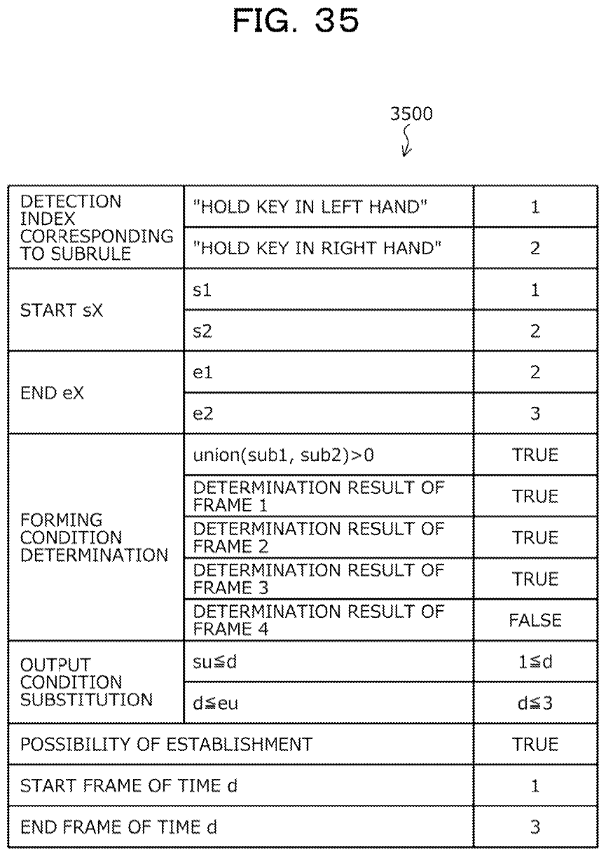

Next, an example in which the information processing device 100 specifies the time in which the target action has been performed in the third motion example will be described with reference to FIGS. 34 and 35.

FIGS. 34 and 35 are explanatory diagrams illustrating examples of specifying the time in which the target action has been performed in the third motion example. In FIG. 34, the information processing device 100 recognizes the elemental action as illustrated in Table 3400 on the basis of the presence or absence of the basic motion for each frame, and specifies the time point sX of the start and the time point eX of the end of the elemental action.

The information processing device 100 specifies, for example, the time point sX of the start and the time point eX of the end of the elemental action “hold a key in the left hand” with reference to the time series analysis rule of the elemental action “hold a key in the left hand”. The information processing device 100 specifies, for example, the time point sX of the start and the time point eX of the end of the elemental action “hold a key in the right hand” with reference to the time series analysis rule of the elemental action “hold a key in the right hand”.

The information processing device 100 specifies the time in which at least one of the elemental action “hold a key in the left hand” and the elemental action “hold a key in the right hand” is established as the time in which the target action has been performed. Next, the description moves onto FIG. 35, and the information processing device 100 specifying the time in which the target action has been performed will be described.

The information processing device 100 sets the time point sX of the start and the time point eX of the end of the x-th elemental action to the time point sx of the start and the time point ex of the end, as illustrated in Table 3500. x corresponds to an index of the elemental action.

The information processing device 100 refers to the action estimation rule 1700 and determines whether the forming condition is TRUE or FALSE. TRUE indicates that the forming condition is satisfied. FALSE indicates that the forming condition is not satisfied. Furthermore, the information processing device 100 determines whether the forming condition is TRUE or FALSE for each frame.

As illustrated in Table 3500, the information processing device 100 determines that the forming condition of union (sub1, sub2)>0 is TRUE as a whole. As illustrated in Table 3500, the information processing device 100 determines whether or not the forming condition of union (sub1, sub2)>0 is TRUE for each frame.

As illustrated in Table 3500, since the forming condition is TRUE as a whole, the possibility of establishment of the target action is TRUE, and the information processing device 100 determines that the target action has been performed. TRUE indicates that the target action is established. Thereby, the information processing device 100 can correctly recognize that the target action has been performed.

Since the target action is established, the information processing device 100 refers to the action estimation rule 1700 and specifies the time in which the output condition is satisfied as the time d in which the target action has been performed. As illustrated in Table 3500, the information processing device 100 specifies the frame 1 the time d in which the target action has been performed the frame 3.

As illustrated in Table 3500, the information processing device 100 stores the frame number 1 indicating the time point of the start of the time d in which the target action has been performed and the frame number 3 indicating the time point of the end. The information processing device 100 outputs the frame number 1 indicating the time point of the start of the time d in which the target action has been performed and the frame number 3 indicating the time point of the end in a referrable manner from the user.

Thereby, the information processing device 100 can accurately specify the time in which the target action has been performed. For example, the information processing device 100 can accurately specify the time in which the target work has been performed in consideration of an incidental time in which an elemental action incidental to the target action has been performed or a blank time in which no elemental action has been performed on the basis of the forming condition and the output condition.

### Fourth Motion Example of Information Processing Device 100

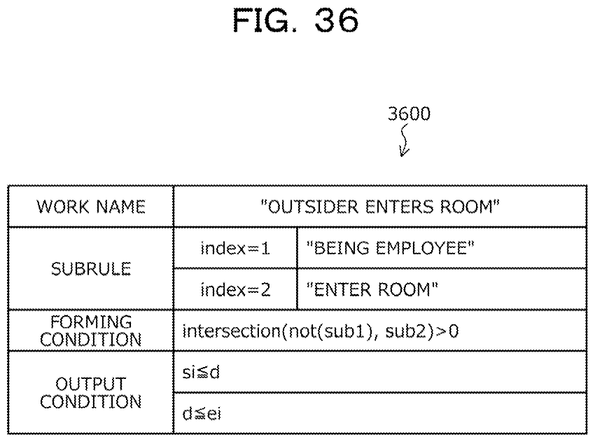

Next, a fourth motion example of the information processing device 100 will be described with reference to FIGS. 36 to 38. The above-described first motion example corresponds to the case where the forming condition defined in the action estimation rule is expressed by the order condition. In contrast, the fourth motion example corresponds to the case where the forming condition defined in the action estimation rule is expressed by the logical condition. For example, the fourth motion example corresponds to the case where the forming condition is expressed by the logical condition using the negation NOT.

First, an example of the action estimation rule for specifying the time in which the target action has been performed in the fourth motion example will be described with reference to FIG. 36. In the following description, the target action is assumed to be “an outsider enters the room”.

FIG. 36 is an explanatory diagram illustrating an example of an action estimation rule in the fourth motion example. For example, FIG. 36 illustrates an action estimation rule 3600 that defines how to specify the time in which a target action “an outsider enters the room” has been performed.

The action estimation rule 3600 includes, for example, a work name indicating a name of the target action “an outsider enters the room”. The action estimation rule 3600 includes, for example, as subrules, elemental action names of the elemental action “being an employee” and the elemental action “enter the room” related to the target action “an outsider enters the room”. Each elemental action is indexed, for example, for convenience.

The action estimation rule 3600 indicates, for example, a forming condition. The forming condition is a condition for determining whether the target action is established. Being established is that the target action has been performed. The forming condition is expressed by at least either the logical condition or the order condition.

The action estimation rule 3600, for example, includes intersection (not(sub1), sub2)>0. sub1 indicates the elemental action “being an employee” of a subrule. not(⋅) indicates negation. not(sub1) indicates negation of the elemental action “being an employee” of the subrule. sub2 indicates the elemental action “enter the room” of a subrule. intersection (not(sub1), sub2)>0 indicates a conditional expression in which there is a time in which the elemental action “enter the room” is established without establishing the elemental action “being an employee”.

The action estimation rule 3600 includes, for example, an output condition that enables specification of the time d in which the target action “an outsider enters the room” has been performed. The output condition corresponds to the output control information.

For example, the action estimation rule 3600 indicates that the time d in which the target action “an outsider enters the room” has been performed is at or after si. si indicates the time point of the start in the time in which the elemental action “being an employee” is not established but the elemental action “enter the room” is established.

For example, the action estimation rule 3600 indicates that the time d in which the target action “an outsider enters the room” has been performed is at or before ei. ei indicates the time point of the end in the time in which the elemental action “being an employee” is not established but the elemental action “enter the room” is established. Thereby, the forming condition and the output condition enable accurate specification of the time in which the target action has been performed.

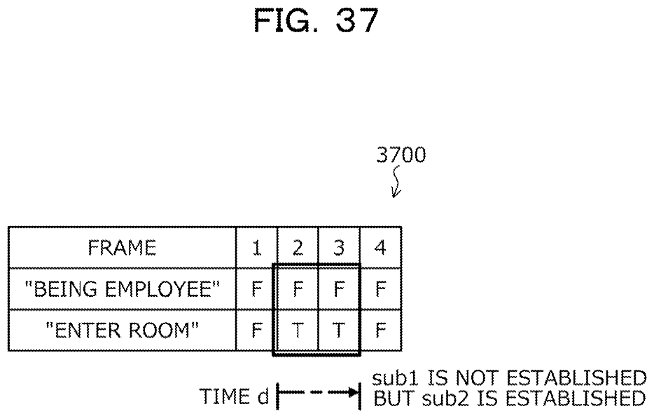

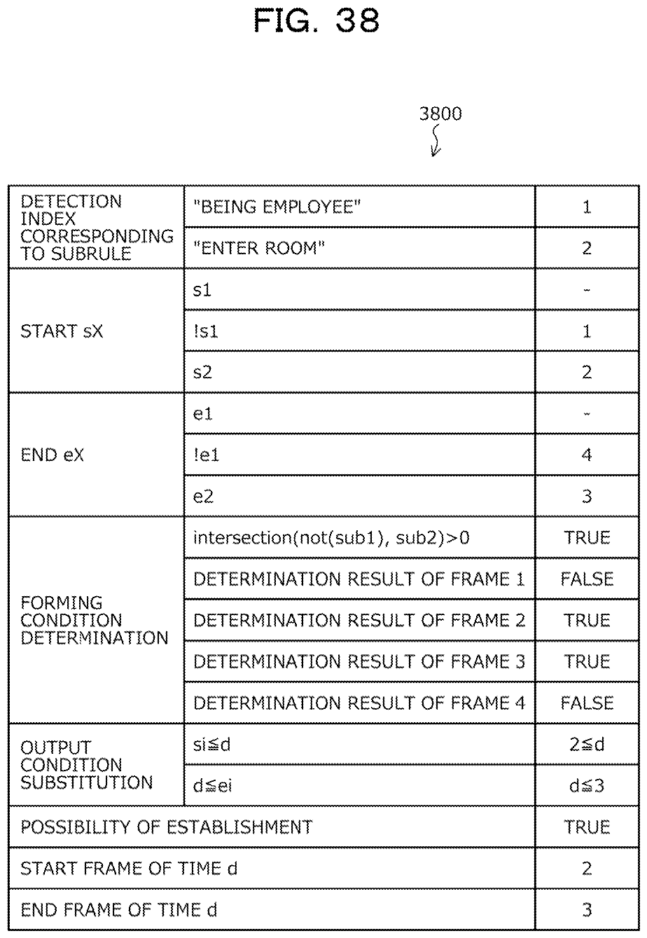

Next, an example in which the information processing device 100 specifies the time in which the target action has been performed in the fourth motion example will be described with reference to FIGS. 37 and 38.

FIGS. 37 and 38 are explanatory diagrams illustrating examples of specifying the time in which the target action has been performed in the fourth motion example. In FIG. 37, the information processing device 100 recognizes the elemental action as illustrated in Table 3700 on the basis of the presence or absence of the basic motion for each frame, and specifies the time point sX of the start and the time point eX of the end of the elemental action.

The information processing device 100 specifies, for example, the time point sX of the start and the time point eX of the end of the elemental action “being an employee” with reference to the time series analysis rule of the elemental action “being an employee”. In the example of FIG. 37, for example, the information processing device 100 does not specify the time point sX of the start and the time point eX of the end of the elemental action “being an employee” and determines that the elemental action “being an employee” is not established as a whole. The information processing device 100 specifies, for example, the time point sX of the start and the time point eX of the end of the elemental action “enter the room” with reference to the time series analysis rule of the elemental action “enter the room”.

The information processing device 100 specifies the time in which the elemental action “being an employee” is not established but the elemental action “enter the room” is established as the time in which the target action has been performed. Next, the description moves onto FIG. 38, and the information processing device 100 specifying the time in which the target action has been performed will be described.

The information processing device 100 sets the time point sX of the start and the time point eX of the end of the x-th elemental action to the time point sx of the start and the time point ex of the end, as illustrated in Table 3800. x corresponds to an index of the elemental action. For example, the information processing device 100 does not set the time point s1 of the start and the time point e1 of the end because the time point sX of the start and the time point eX of the end of the first elemental action are not specified. For example, the information processing device 100 sets the time point sX of the start and the time point eX of the end of the second elemental action to the time point s2 of the start and the time point e2 of the end. As illustrated in Table 3800, the information processing device 100 sets a time point !s1 of the start and the time point !e1 of the end of the time in which the first elemental action is not established.

The information processing device 100 refers to the action estimation rule 1700 and determines whether the forming condition is TRUE or FALSE. TRUE indicates that the forming condition is satisfied. FALSE indicates that the forming condition is not satisfied. Furthermore, the information processing device 100 determines whether the forming condition is TRUE or FALSE for each frame.

As illustrated in Table 3800, the information processing device 100 determines that the forming condition of intersection (not(sub1), sub2)>0 is TRUE as a whole. As illustrated in Table 3800, the information processing device 100 determines whether or not the forming condition of intersection (not(sub1), sub2)>0 is TRUE for each frame.

As illustrated in Table 3800, since the forming condition is TRUE as a whole, the possibility of establishment of the target action is TRUE, and the information processing device 100 determines that the target action has been performed. TRUE indicates that the target action is established. Thereby, the information processing device 100 can correctly recognize that the target action has been performed.

Since the target action is established, the information processing device 100 refers to the action estimation rule 1700 and specifies the time in which the output condition is satisfied as the time d in which the target action has been performed. As illustrated in Table 3800, the information processing device 100 specifies the frame 2 the time d in which the target action has been performed the frame 3.

As illustrated in Table 3800, the information processing device 100 stores the frame number 2 indicating the time point of the start of the time d in which the target action has been performed and the frame number 3 indicating the time point of the end. The information processing device 100 outputs the frame number 2 indicating the time point of the start of the time d in which the target action has been performed and the frame number 3 indicating the time point of the end in a referrable manner from the user.

Thereby, the information processing device 100 can accurately specify the time in which the target action has been performed. For example, the information processing device 100 can accurately specify the time in which the target work has been performed in consideration of an incidental time in which an elemental action incidental to the target action has been performed or a blank time in which no elemental action has been performed on the basis of the forming condition and the output condition.

(Overall Processing Procedure)

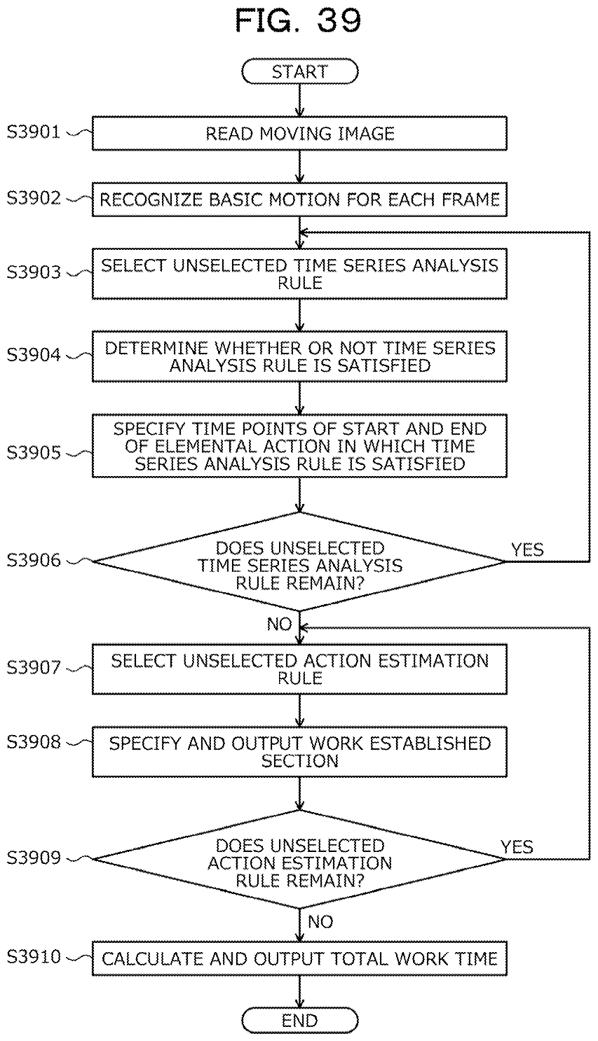

Next, an example of an overall processing procedure executed by the information processing device 100 will be described with reference to FIG. 39. Overall processing is implemented by, for example, the processor 301, the storage area such as the memory 302 or the recording medium 305, and the network I/F 303 illustrated in FIG. 3.

FIG. 39 is a flowchart illustrating an example of an overall processing procedure. In FIG. 39, the information processing device 100 reads a moving image (step S3901). Next, the information processing device 100 recognizes the basic motion for each frame included in the read moving image, using a predetermined model (step S3902).

Next, the information processing device 100 selects the time series analysis rule that has not yet been selected from a plurality of time series analysis rules (step S3903). Then, the information processing device 100 determines whether the selected time series analysis rule is satisfied in the time series statistic amount related to the recognized basic motion (step S3904). After that, the information processing device 100 specifies the time points of the start and the end of the elemental action in which the time series analysis rule is satisfied (step S3905).

Next, the information processing device 100 determines a time series analysis rule that has not yet been selected remains (step S3906). Here, in a case where the time series analysis rule that has not yet been selected remains (step S3906: Yes), the information processing device 100 returns to the processing of step S3903. On the other hand, in a case where all the time series analysis rules have been selected (step S3906: No), the information processing device 100 proceeds to the processing of step S3907.

In step S3907, the information processing device 100 selects the action estimation rule that has not yet been selected from the plurality of action estimation rules (step S3907). Next, the information processing device 100 refers to the forming condition and the end condition indicated by the selected action estimation rule, and specifies and outputs a work established section in which the target work corresponding to the target action has been performed (step S3908).

Next, the information processing device 100 determines whether or not the action estimation rule that has not yet been selected remains (step S3909). Here, in a case where the action estimation rule that has not yet been selected remains (step S3909: Yes), the information processing device 100 returns to the processing of step S3907. On the other hand, in a case where all the action estimation rules have been selected (step S3909: No), the information processing device 100 proceeds to the processing of step S3910.

In step S3910, the information processing device 100 aggregates, for each type of work, the work established sections in which the work of the type has been performed, and calculates and outputs a total work time in which the work of the type has been performed (step S3910). Then, the information processing device 100 ends the overall processing. Thereby, the information processing device 100 can accurately specify the work time in which the work has been performed.

Here, the information processing device 100 may exchange some steps in the processing order in FIG. 39 and execute the processing. Furthermore, the information processing device 100 may omit some steps in the processing in FIG. 39.

As described above, according to the information processing device 100, it is possible to acquire at least one of time points of the start or the end of each of elemental actions related to the target action specified on the basis of the moving image related to the target action. According to the information processing device 100, it is possible to store a predetermined rule that provides at least one of the logical condition for the elemental action related to the target action or the order condition between the elemental actions related to the target action, which is satisfied in the case where the target action is performed. According to the information processing device 100, it is possible to generate the information that enables specification of the time in which the target action has been performed on the basis of the acquired time points by referring to the predetermined rule. With this configuration, the information processing device 100 can improve the accuracy of specifying the time in which the target action has been performed.

According to the information processing device 100, it is possible to recognize the motion for each frame included in the moving image, and specify the frame corresponding to the elemental action related to the target action from among the frames included in the moving image on the basis of the recognized motion. According to the information processing device 100, it is possible to determine whether the ratio of specified frames included in each of two consecutive periods satisfies the condition corresponding to the period. According to the information processing device 100, it is possible to specify the time point at the boundary between the two periods as the any time point of the start or the end of the elemental action related to the target action when the ratio of the specified frames included in each of the periods satisfies the condition corresponding to the period. Thereby, the information processing device 100 can accurately specify any time point of the start or the end of the elemental action, and can improve the accuracy of specifying the time in which the target action has been performed.

According to the information processing device 100, it is possible to store the predetermined rule further providing the correspondence relationship between at least one of time points of the start or the end of any elemental action related to the target action and at least one of time points of the start or the end of the time in which the target action has been performed. According to the information processing device 100, it is possible to generate the information including at least one of time points of the start or the end of the time in which the target action has been performed on the basis of the acquired time points with reference to the predetermined rule. Thereby, the information processing device 100 can accurately specify at least one of time points of the start or the end of the time in which the target action has been performed, and can improve the accuracy of specifying the time in which the target action has been performed.

According to the information processing device 100, it is possible to store the predetermined rule that provides the order condition that defines a predetermined order in which each elemental action of two or more elemental actions related to the target action is performed, which is satisfied in the case where the target action is performed. Thereby, the information processing device 100 can accurately determine whether or not the predetermined action has been performed on the basis of the order in which each elemental action of the two or more elemental actions has been performed, and can improve the accuracy of specifying the time in which the target action has been performed.

According to the information processing device 100, it is possible to store a predetermined rule that provides the logical condition that defines two or more elemental actions related to the target action are performed at the same time, which is satisfied in the case where the target action is performed. Thereby, the information processing device 100 can accurately determine whether a predetermined action has been performed on the basis of the logical relationship between the elemental actions, and can improve the accuracy of specifying the time in which the target action has been performed.

According to the information processing device 100, it is possible to store a predetermined rule that provides the logical condition that defines at least one of two or more elemental actions related to the target action is performed at the same time, which is satisfied in the case where the target action is performed. Thereby, the information processing device 100 can accurately determine whether a predetermined action has been performed on the basis of the logical relationship between the elemental actions, and can improve the accuracy of specifying the time in which the target action has been performed.

According to the information processing device 100, it is possible to store a predetermined rule that provides the logical condition that defines one of the elemental actions related to the target action is not performed, which is satisfied in the case where the target action is performed. Thereby, the information processing device 100 can accurately determine whether a predetermined action has been performed on the basis of the logical relationship between the elemental actions, and can improve the accuracy of specifying the time in which the target action has been performed.

According to the information processing device 100, it is possible to generate the skeleton information indicating the position of the target skeleton for each frame included in the moving image, and recognize the target motion on the basis of the generated skeleton information for each frame included in the moving image. Thereby, the information processing device 100 can accurately recognize the target motion and can accurately recognize the elemental action.

Note that the information processing method described in the present embodiment may be implemented by executing a program prepared in advance, on a computer such as a personal computer (PC) or a workstation. The information processing program described in the present embodiment is executed by being recorded on a computer-readable recording medium and being read from the recording medium by the computer. The recording medium is a hard disk, a flexible disk, a compact disc (CD)-ROM, a magneto-optical disc (MO), a digital versatile disc (DVD), or the like.

In addition, the information processing program described in the present embodiment may be distributed via a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an information processing program for causing a computer to execute processing comprising:
acquiring at least one of time points of start or end of each elemental action related to an action specified on a basis of a moving image of the action; and
generating information that enables specification of a time in which the action has been performed on a basis of the acquired time point with reference to a rule that provides at least one of a logical condition for the elemental action related to the action or an order condition between the elemental actions related to the action, the logical condition or the order condition being satisfied in a case where the action is performed.

2. The non-transitory computer-readable recording medium according to claim 1, wherein
the processing of acquiring includes
recognizing a motion for each frame included in the moving image,
specifying a frame that corresponds to the elemental action related to the action from among the frames included in the moving image on a basis of the motion, and
specifying, in a case where a ratio of the specified frames included in each period of two consecutive periods satisfies a condition that corresponds to the period, a time point at a boundary between the two periods as the one of time points of start or end of the elemental action related to the action.

3. The non-transitory computer-readable recording medium according to claim 1, wherein
the rule provides the at least one of a logical condition for the elemental action related to the action or an order condition between the elemental actions related to the action, the logical condition or the order condition being satisfied in the case where the action is performed, in association with a correspondence relationship between the at least one of time points of start or end of the elemental action related to the action, and at least one of time points of start or end of a time in which the action has been performed, and
the processing of generating includes generating information that includes the at least one of time points of start or end of a time in which the action has been performed on the basis of the acquired time point with reference to the rule.

4. The non-transitory computer-readable recording medium according to claim 1, wherein
the rule provides the order condition that defines a predetermined order in which each elemental action of two or more elemental actions related to the action is performed, the order condition being satisfied in the case where the action is performed.

5. The non-transitory computer-readable recording medium according to claim 1, wherein
the rule provides the logical condition that defines that two or more elemental actions related to the action are performed at a same time, the logical condition being satisfied in the case where the action is performed.

6. The non-transitory computer-readable recording medium according to claim 1, wherein
the rule provides the logical condition that defines that at least one of two or more elemental actions related to the action is performed, the logical condition being satisfied in the case where the action is performed.

7. The non-transitory computer-readable recording medium according to claim 1, wherein
the rule provides the logical condition that defines that one of elemental actions related to the action is not performed, the logical condition being satisfied in the case where the action is performed.

8. The non-transitory computer-readable recording medium according to claim 2, wherein
the processing of acquiring includes
generating skeleton information that indicates a position of a target skeleton for each frame included in the moving image, and recognizing the target motion on a basis of the generated skeleton information for each frame included in the moving image.

9. An information processing method comprising:
acquiring at least one of time points of start or end of each elemental action related to an action specified on a basis of a moving image of the action; and
generating information that enables specification of a time in which the action has been performed on a basis of the acquired time point with reference to a rule that provides at least one of a logical condition for the elemental action related to the action or an order condition between the elemental actions related to the action, the logical condition or the order condition being satisfied in a case where the action is performed.

10. An information processing device comprising:
a memory; and
a processor coupled to the memory and configured to:
acquire at least one of time points of start or end of each elemental action related to an action specified on a basis of a moving image of the action; and
generate information that enables specification of a time in which the action has been performed on a basis of the acquired time point with reference to a rule that provides at least one of a logical condition for the elemental action related to the action or an order condition between the elemental actions related to the action, the logical condition or the order condition being satisfied in a case where the action is performed.
